(19) United States
(12) Patent Application Publication
(10) Pub. No.: US 2026/0366676 A1
(43) Pub. Date: Nov. 19, 2026

(54) A COOLING SYSTEM OF A HYDROGEN REFUELING STATION

(71) Applicant: CAVENDISH HYDROGEN A/S, Herning (DK)

(72) Inventors: Marcin Blazniak ANDREASEN, Hovedgård (DK); Balint EGRI, Vejle (DK); Lennart Sune SKOUSEN, Nørre Aaby (DK)

(21) Appl. No.: 19/132,061

(22) PCT Filed: Nov. 29, 2023
(86) PCT No.: PCT/DK2023/050289

§ 371 Date: May 22, 2025

(30) Foreign Application Priority Data
Nov. 29, 2022 (DK) PA202270577

(51) Int. Cl. F17C 5/06; F16K 31/00

(52) U.S. Cl. CPC F17C 5/06; F16K 31/004; F17C 2221/012; F17C 2250/0439

(57) ABSTRACT

A hydrogen refueling station including a heat exchanger in which a hydrogen pipe part is coiled around a center filler, the hydrogen pipe part enters and leaves the heat exchanger via a top flange and a bottom flange, the heat exchanger includes a coolant entrance and a coolant exit, the coolant entrance enables a coolant to enter the heat exchanger in a direction perpendicular to the longitudinal direction of the center filler. A coolant pump is configured for introducing the coolant into the heat exchanger via the coolant entrance thereby establishing a radial swirling coolant flow in the heat exchanger around the the center filler towards the coolant exit, and where the swirling coolant flow is fluidly in contact with the the hydrogen pipe part and thereby facilitating exchange of heat between the swirling coolant and the gaseous hydrogen flowing in the hydrogen pipe part.

### TECHNICAL FIELD

The disclosure relates to a hydrogen refueling station comprising a heat exchanger, a cooling system comprising such heat exchanger and a method of assembling such heat exchanger.

### BACKGROUND

In the art pipe in pipe heat exchangers are known. Such heat exchangers may comprise bafflers for guiding a coolant along a flow path from a coolant inlet towards a coolant outlet to increase cooling capacity of the coolant. Such bafflers may be perforated to allow pipes circulating a medium to be cooled through the bafflers. With respect to assembling and design, such perforated bafflers are not suitable for heat exchangers having pipes formed as a spiral.

Cooling systems for hydrogen refueling systems are known and in WO 2016 180425 A1 a such cooling system comprising a heat exchanger in which a solid-state cooling bank can be built is described. Such heat exchanger/cooling bank is advantageous in that cooling capacity can be built up during periods where no vehicles are refueled and used when vehicles are to be filled. This system requires energy to establish and maintain the presence of the cooling bank and when the cooling bank is used, the cooling capacity of the refueling station is reduced.

Thus, with an increased demand for hydrogen gas used as fuel for vehicles, in particular heavy-duty vehicles, cooling capacity of a refueling station need to be on a stable high level with as low power consumption and footprint as possible. Together with restrictions to physical layout of heat exchangers and piping for hydrogen gas pressurized to comply with requirements for fueling of fuel cell vehicles, a new cooling system design is needed.

### BRIEF SUMMARY

The inventors have identified the above-mentioned problems and challenges related to cooling capacity of cooling systems for hydrogen refueling stations and solved these problems by the present disclosure as described below. Simply introduce more pipes into a heat exchanger design to increase heat exchange capacity is not possible due to physical layout of the heat exchanger (not more space in flange for additional pipes and no space in the hydrogen refueling station for increase length of hydrogen pipes/heat exchanger). Further problems occur, because hydrogen pipes cannot be welded due to operation pressure (they are typically connected either by screwing or a through SwageLock connection). Further, hydrogen is kept in pipes in the shell to avoid hydrogen connection/welding's in direct contact with the coolant to avoid the risk of leaking.

To overcome these difficulties, the inventors have developed a cooling system for a hydrogen refueling station which in an aspect, relates to a hydrogen refueling station comprising a hydrogen storage fluidly connected to a hydrogen dispenser via a hydrogen pipe, said hydrogen dispenser is fluidly connectable to a receiving vessel via a nozzle. Wherein at least part of said hydrogen pipe is coiled and extending in a longitudinal direction of an inner compartment of a high-capacity pipe in pipe heat exchanger configured for cooling a pressurized gaseous hydrogen flowing in said hydrogen pipe part. Wherein said heat exchanger comprises an outer pipe having an outer side, a coolant side defining said inner compartment with a first diameter, a top flange, a bottom flange and a center filler. Wherein said hydrogen pipe part is coiled around said center filler, wherein said hydrogen pipe part enters and leaves said inner compartment via said top flange and said bottom flange, wherein said coil is having a second diameter which is less than said first diameter. Wherein said outer pipe comprising a coolant entrance and a coolant exit, wherein said coolant entrance enable a coolant to enter said inner compartment in a direction perpendicular to the longitudinal direction of said outer pipe. Wherein a coolant pump is configured for introducing said coolant into said inner compartment via said coolant entrance thereby establishing a radial swirling coolant flow in said inner compartment around said center filler towards said coolant exit. Wherein said swirling coolant flow is fluidly in contact with said hydrogen pipe part and thereby facilitating exchange of heat between said swirling coolant and said gaseous hydrogen flowing in said hydrogen pipe part.

The heat exchanger is advantageous in that it combines a large surface area of the hydrogen pipe with an enhanced heat transfer coefficient generated by the swirling coolant flow around the center filler. This is due to the combination of the reduced volume of the inner compartment occupied by the center filler and the perpendicular introduction of the coolant.

Thereby the hydrogen refueling station is able to provide a higher hydrogen flow to the receiving vessel for a longer period of time while keeping the pressurized hydrogen gas below a predetermined temperature compared to refueling stations comprising known cooling systems. In other words, the cooling capacity of the cooling system is increased without increasing the size of the heat exchanger.

A hydrogen refueling station should be understood as intended for refueling fuel cell vehicle and in particular for refueling heavy-duty vehicles. With this said it should be mentioned that it could also be used for refueling of light-duty vehicle. Also, other types of vehicles could be refueled by a refueling station having a cooling system comprising a high-capacity heat exchanger as described above. Examples of such types of vehicles include aeroplanes, trains, agricultural vehicles, ships, etc.

The hydrogen pipe should be understood as the conductor of hydrogen from hydrogen storage to nozzle. Thus, the hydrogen pipe may be a pipe joint by a plurality of different parts. One part may be a flexible hose from dispenser to nozzle, another part may be the partly coiled part inside the inner compartment of the heat exchanger.

Pressurized gaseous hydrogen should be understood as sufficing to refueling a receiving vessel of a fuel cell vehicle. Hence, the pressurized gas should be understood as having pressure between 20 Mpa and 100 Mpa such as 35 Mpa-75 Mpa, but could in principle be both higher and lower pressures.

In an exemplary embodiment of the disclosure, said high-capacity pipe in pipe heat exchanger is configured for cooling an average hydrogen flow through of at least 6.5 kg/min.

A high-capacity pipe in pipe heat exchanger should be understood as a heat-exchanger which is able to cool an average flow of hydrogen between 5 kg/min and 10 kg/min during normal operation. The is to be able to comply with the large volumes of hydrogen which is needed to refuel e.g. a heavy-duty vehicle. With this said it should be mentioned that the heat exchanger may be able to cool peak flows up to 18 kg/min or even higher.

In an exemplary embodiment of the disclosure, said coolant is a brine In an exemplary embodiment of the disclosure, the temperature of said brine is between 5 °C and −30 °C, preferably between 0 °C and −20 °C most preferably between 0 °C and −15 °C.

Preferably, the coolant in the heat exchanger of the present disclosure does not change phase i.e. does not evaporate. Hence the coolant could be water or an Ethyleneglycol solution which ensures the coolant does not change to solid state due to cold ambient temperatures. An Ethyleneglycol solution ensure the coolant does not change to a solid stage within its frost protected range which could be down to −50C.

In an exemplary embodiment of the disclosure, said inner compartment is separated in two inner sub-compartments by a compartment separator.

Separating the inner compartment into two or more inner sub-compartments or in two or more independent heat exchangers, is advantageous in that it has the effect, that coolant can be reintroduced into the inner sub-compartment/inner compartments of independent heat exchangers. This increases the speed of the swirling flow and ensures that coolant flow stream along the hydrogen pipe path leading to an increase of heat rejection from hydrogen pipes.

In an exemplary embodiment of the disclosure, said compartment separator comprises at least the number of through holes corresponding to the number of hydrogen coils in said two inner sub-compartments.

The compartment separator may be implemented as a disk like separator having a diameter corresponding to the first diameter (i.e. diameter of the inner compartment which may in an example be Ø200 mm). The compartment separator may be made of a plastic material such as thermoplastic PEHD or the like having holes through which hydrogen pipes can extend. The compartment separator may comprise recess enabling the mounting of an O-ring for sealing between the two sub-compartments. Such recesses may be in the holes through which the hydrogen pipes are extending and in the outer circumference towards the coolant side of the outer pipe. It should be mentioned that the compartment separator may not necessarily seal the two sub-compartments completely from each other, most important is that it ensures flow out of the first and into the second sub-compartment. The compartment separator may be glued to the coolant side or to the center filler so that sealing may only be necessary between the compartment separator and either of the center filler and the coolant side.

It should be mentioned that the compartment separator may also comprise a through hole through which the center filler can extend.

In an exemplary embodiment of the disclosure, said hydrogen pipe part extending through said compartment separator is a coiled hydrogen pipe in a first inner sub-compartment and a non-coiled hydrogen pipe in a second inner sub-compartment.

Dividing the hydrogen pipe part 4a in a coiled and non-coiled part is advantageous in that it eases the assembly of the heat exchanger i.e. the implementation of the compartment separator inside the inner compartment.

A non-coiled hydrogen pipe may be implemented as a straight hydrogen pipe. The part of the hydrogen pipe extending through the compartment separator may be parallel to the coolant side of the outer pipe.

In an exemplary embodiment of the disclosure, said coolant entrance is displaced from the center of said outer side when seen in a top view.

This is advantageous in that it has the effect, that the speed with which the coolant is introduced is not reduced by the coolant hitting the center filler. Further, it is advantageous in that it is thereby ensured, that the introduced coolant swirls the same way around the center filler and ensures that coolant flow stream along the hydrogen pipe path.

The coolant exit is preferably also located displaced from the center of the outer side seen in a top view. In fact, when seen in a top view the coolant entrance and exit may be in front of each other.

In an exemplary embodiment of the disclosure, the longitudinal distance between said coolant entrance and said coolant exit is at least 200 mm, preferably at least 300 mm, most preferably at least 400 mm.

It should be mentioned that the shorter distance the higher velocity in the swirling flow. Hence, the distance between the entrance and exit is balanced between swirling velocity, number of sub-compartments/individual inner compartments and total length of the hydrogen pipe.

This distance depends on the number of coils inside the outer pipe, typically, the more coils the longer distance. As an example of three coils, the distance could be 450 mm

In an exemplary embodiment of the disclosure, a diameter of an orifice of said coolant entrance is larger than the inner diameter of said hydrogen pipe.

This is advantageous in that it has the effect, that speed of the coolant is increased when entering the hydrogen pipe. By introducing the coolant via a narrow orifice, the velocity with which it enters the inner compartment is increased compared to introduction via a wide orifice. The high velocity is leading to a higher turbulence/swirling effect which again is leading to a higher heat rejection to the coolant from hydrogen pipes.

In an exemplary embodiment of the disclosure, an inner diameter of at least part of said coolant entrance is less than 50 mm, preferably less than 35 mm, most preferably less than 21 mm

In an exemplary embodiment of the disclosure, an inner diameter of said coolant entrance is less than an inner diameter of said coolant exit.

This is advantageous in that it has the effect, that speed of the coolant is increased when entering the hydrogen pipe.

In an exemplary embodiment of the disclosure, said coolant enters said inner volume with a velocity between 5 m/s and 15 m/s, preferably between 7 m/s and 13 m/s, most preferably 9 m/s or 10 m/s.

In an exemplary embodiment of the disclosure, said coolant pump configured for circulating said coolant is located in a coolant flow loop between said coolant exit and a secondary heat exchanger.

This is advantageous in that heat introduced by the pump to the coolant does not have effect on the temperature of the coolant entering the inner compartment. This is because between the pump and the entrance the temperature of the coolant is reduced by the secondary heat exchanger.

In an exemplary embodiment of the disclosure, said center filler is a solid rod.

The center filler is advantageous in that it reduced coolant volume of the inner volume and thereby having the effect that velocity of coolant is higher in that the volume of coolant that should be moving is reduced. Also, the location of the center filler in the middle of the hex ensures a swirling flow around it.

In an exemplary embodiment of the disclosure, said center filler is a hollow pipe comprising additional hydrogen pipes.

Including additional hydrogen pipes inside the center filler is advantageous in that a second cooling stage is established. Such second cooling stage may either be a first or a second cooling stage. In a preferred embodiment, the additional hydrogen pipes are used as a second cooling stage i.e. gaseous hydrogen leaves the heat exchanger via a manifold connected to these additional hydrogen pipes.

In an exemplary embodiment of the disclosure, said hollow center filler comprises bafflers extending from the circumference of said hollow center filler towards the center of said hollow center filler.

Bafflers are advantageous in that they will lead the coolant from one side in the hollow center filler to the other side of the hollow center filler causing the coolant to cross the hydrogen pipes and thereby enhancing the heat transfer from hydrogen pipes.

In an exemplary embodiment of the disclosure, the outer diameter of said center filler is between 50 mm and 100 mm, preferably between 60 mm and 80 mm, most preferably between 65 mm and 75 mm.

The dead volume inside the coiled hydrogen pipes cannot be avoided due to bending radius of hydrogen pipes. The diameter of the dead volume may in an example be Ø85 mm hence, the diameter of the center filler should in this example be less than Ø85 mm such as Ø70 mm. Thus, occupying this dead volume with a center filler is advantageous for reasons explained above. Hence, the outer diameter is determined at least partly based on the bending radius of the hydrogen pipes.

In an exemplary embodiment of the disclosure, two or more parts of hydrogen pipe are connected to said hydrogen pipe 4 via a manifold.

As an example, the inner diameter of a hydrogen pipe may be in the range of 2 mm to 10 mm such as 5 mm.

In an exemplary embodiment of the disclosure, said two or more parts of hydrogen pipe are coiled with different diameters.

This is advantageous in that it has the effect, that two, three or more layers of coiled hydrogen pipes can be positioned inside the inner compartment. Thereby enabling more surface area of the hydrogen pipe to be cooled by coolant in the inner compartment.

In case of three coiled hydrogen parts in one sub-compartment the diameters of these three coiled parts are all less than the inner diameter of the outer pipe. Further, the diameters are all different to allow three layers of coiled parts inside one compartment. As an example, the if the center filler diameter is Ø70 mm and the inner compartment diameter is Ø200 mm which may be the case if the inner compartment should comprise three coils, then the diameter of the three coils are between Ø70 mm and Ø200 mm.

In an exemplary embodiment of the disclosure, said two or more coiled parts of hydrogen pipe are located in the same sub-compartment.

Hence if a heat exchanger comprises two sub-compartments, then one part of hydrogen pipe can be coiled with one diameter in one sub-compartment and goring through the other sub-compartment is a substantially straight line. In the sub-compartment where it is coiled two additional coiled part of hydrogen pipes may be positioned and going through the other sub-compartment is a substantially straight line. In the same way three parts of hydrogen pipe can be coiled in the other sub-compartment. Hence, in total six partly coiled hydrogen pipe parts are included in the heat exchanger. All first ends thereof may be connected to the hydrogen pipe providing pressurized gaseous hydrogen from the hydrogen storage to the heat exchanger via a first manifold. All second ends thereof may be connected to the hydrogen pipe delivering pressurized gaseous hydrogen to the dispenser from the heat exchanger via a second manifold.

In an exemplary embodiment of the disclosure, the length of each of said at least part of said hydrogen pipe is 1 meter and 20 meters, preferably between 5 meters and 17 meters, most preferably between 9 meters and 14 meters.

The length of the part of the hydrogen pipe which is inside the outer pipe is desired to be as long as possible to have as much surface to be cooled as possible. Hence a 12 meter hydrogen pipe part may, when partly coiled, have a length of 1 m. Of this length e.g. 450 mm may be coiled with a pith of e.g. 12 mm in a first compartment and another 450 mm may be a straight part through a second compartment. In both ends, some straight parts may be used to connect to the hydrogen pipe e.g. via manifold . . . .

In an exemplary embodiment of the disclosure, a pitch length of the coiled part of said at least part of said hydrogen pipe is between 5 mm and 20 mm, preferably between 7 mm and 17 mm, most preferably between 10 mm and 15 mm.

The pitch length of the part of the hydrogen that is coiled inside the outer pipe is balanced between a “too large” and a “too small” pitch length. Large pitch length such as at or above 20 mmwill make the heat exchanger extensively long such as over 1.5m while a “small pitch length” such as below 10 mm will block the path between the coils to an extend where it may lead to an increasing pressure drop and reducing heat transfer to the coolant.

In an exemplary embodiment of the disclosure, at least 50%, preferably at least 75%, most preferably at least 90% of said hydrogen pipe 4 is coiled and located inside said inner compartment 7.

This is advantageous in that it has the effect, that efficiency of the heat exchanger is increased in that as much as possible of the hydrogen pipe in contact with coolant.

The part of the hydrogen pipe not being coiled may partly be a straight line through a sub-compartment and partly outside the inner compartment. As an example of a 12m hydrogen pipe 11m may be coiled less than 0.3m is outside the inner compartment and rest is straight going through a sub-compartment. It should be mentioned that the coiled part may depend on the diameter of the coil. Thus, the coiled part of an inner and an outer coiled hydrogen pipe in the same sub-compartment may not be the same.

In an exemplary embodiment of the disclosure, a first manifold set separates flow of pressurized gaseous hydrogen from flow in one hydrogen pipe to flow in 2-9 hydrogen pipe parts.

In an exemplary embodiment of the disclosure, a first subset of said 2-9 hydrogen pipe parts are coiled with different diameters in a first sub-compartment and a second subset of said 2-9 hydrogen pipe parts are coiled with different diameters in a second sub-compartment.

This is advantageous in that then the area of hydrogen pipe in the inner compartment is increased. As an example, four coiled hydrogen pipes are comprised by each of a first and second sub-compartment.

In an exemplary embodiment of the disclosure, a second manifold set separates flow of pressurized gaseous hydrogen from flow in 2-9 hydrogen pipe parts to flow in 2-9 additional hydrogen pipes.

Using manifolds to such separation of flow from one to many is advantageous in that assembling is easier and risk of leakages is reduced.

In an exemplary embodiment of the disclosure, said parts of hydrogen pipe and said addition hydrogen pipes are fluidly connected via a first manifold and a second manifold.

This is advantageous in that it has the effect, that several hydrogen pipe parts can be connected with several additional hydrogen pipes and thereby increased hydrogen pipe surface area inside the outer pipe.

A hydrogen refueling station according to any of the paragraphs [0006]-[0067] comprising a cooling system according to any of the paragraphs [0069]-[0090].

In an aspect, the disclosure relates to a hydrogen refueling station cooling system comprising at least two cooling stages for cooling a flow of hydrogen in a hydrogen pipe. Wherein said first cooling stage is configured for cooling gaseous hydrogen in a hydrogen pipe guiding a flow of said gaseous hydrogen from a hydrogen storage through a first heat exchanger, wherein said first heat exchanger is fluidly connected to a thermal energy storage of a coolant flow loop, and wherein said second cooling stage is configured for cooling said flow of gaseous hydrogen from said first heat exchanger by a third heat exchanger, wherein said third heat exchanger is fluidly connected to a chiller of said coolant flow loop. Wherein said chiller is configured for established said thermal energy storage when there is no flow of gaseous hydrogen in said hydrogen pipe. And, wherein at least part of said hydrogen pipe is coiled and extending in a longitudinal direction of an inner compartment of at least said first heat exchanger and/or said third heat exchanger, wherein said heat exchanger comprises an outer pipe having an outer side, a coolant side defining said inner compartment with a first diameter, a top flange, a bottom flange and a center filler, wherein said hydrogen pipe part is coiled around said center filler, wherein said hydrogen pipe part enters and leaves said inner compartment via said top flange and said bottom flange, wherein said coil is having a second diameter which is less than said first diameter, wherein said outer pipe comprising a coolant entrance and a coolant exit, wherein said coolant entrance enable a coolant to enter said inner compartment in a direction perpendicular to the longitudinal direction of said outer pipe, wherein a coolant pump is configured for introducing said coolant into said inner compartment via said coolant entrance thereby establishing a radial swirling coolant flow in said inner compartment around said center filler towards said coolant exit, wherein said swirling coolant flow is fluidly in contact with said hydrogen pipe part 4a and thereby facilitating exchange of heat between said swirling coolant and said gaseous hydrogen flowing in said hydrogen pipe part.

Such cooling system is advantageous in that it has the effect, that the thermal energy storage is cooling coolant used in the first heat exchanger to cool the hydrogen. Further, such cooling system is advantageous in that it has the effect, that the chiller unit is able to build up the thermal energy storage.

Further such cooling system is advantageous in that it has the effect, that it is very flexible in that several cooling stages can be operated simultaneously and simultaneous with recovering the thermal energy storage. Examples could be mentioned that include the chiller is able to cool hydrogen in the second cooling stage and/or build up the thermal energy storage and/or indirectly via the low temperature cooling loop cool coolant in the additional coolant flow loop of the third stage at the same time as the hydrogen is cool in the first stage based on cooling energy available from the thermal energy storage, etc.

In an exemplary embodiment of the disclosure, said first heat exchanger is a high-capacity pipe in pipe heat exchanger.

In an exemplary embodiment of the disclosure, said chiller is configured for cooling coolant where at least one of a coolant pump and a chiller pump is configured for establishing a flow of said cooled coolant in a coolant flow loop into said first heat exchanger, said thermal energy storage and said third heat exchanger.

In an exemplary embodiment of the disclosure, said thermal energy storage is configured for cooling coolant conducted through said first heat exchanger during refueling of a receiving vessel.

Using the thermal energy storage to cool hydrogen in a first cooling stage is advantageous in that it has the effect, that the chiller then is able to focus capacity on cooling hydrogen in the second and/or third cooling stage.

Further, the thermal energy storage is used to cascade the temperature to a lower level resulting in a lower load on the cooling system, reduced power consumption, improved daily coefficient of performance of the cooling system and a reduced size of the chiller and heat exchangers of the cooling system.

In an exemplary embodiment of the disclosure, said third heat exchanger is a pipe in pipe heat exchanger.

The third heat exchanger may be a high-capacity pipe in pipe heat exchanger of the type swirling type described above.

In an exemplary embodiment of the disclosure, said hydrogen refueling station cooling system comprises a fourth heat exchanger.

A three-stage cooling system is advantageous in that during refueling of a receiving vessel of a fuel cell vehicle because the hydrogen has to be cooled to a low temperature such as between minus 35 °C and minus 15 °C.

In an exemplary embodiment of the disclosure, said first stage temperature is lower than 5 °C, preferably down to 0 °C.

In an exemplary embodiment of the disclosure, said second stage temperature is lower than −5 °C, preferably lower than −15 °C.

In an exemplary embodiment of the disclosure, said hydrogen refueling station cooling system comprises a third cooling stage configured for cooling said flow of gaseous hydrogen from said third high-capacity exchanger by a fourth heat exchanger, wherein said fourth heat exchanger is fluidly connected to a low temperature cooling loop, wherein temperature of coolant of said low temperature cooling loop is reduced by heat exchange with coolant of said coolant flow loop.

In an exemplary embodiment of the disclosure, said fourth high-capacity heat exchanger is a pipe in pipe heat exchanger.

Preferably the fourth high-capacity heat exchanger is of the type swirling type described above.

In an exemplary embodiment of the disclosure, said third stage temperature is lower than −15 °C.

In an exemplary embodiment of the disclosure, said predetermined gaseous hydrogen refueling temperature is in the range of 0to −30 , preferably of −5 to −20, most preferably of −10 to −15.

Such multistage cooling system is advantageous in that it has the effect, that it efficiently and fast is able to cool gaseous hydrogen from a storage temperature (which may be ambient temperature) to a first stage, second stage and finally a third stage temperature which is desired for gaseous hydrogen that need to be filled into a receiving vessel.

More specific, the advantage of having more cooling stages is that the efficiency of the hydrogen cool system is high as the energy can be exchanged at highest possible temperature level.

Further, with several stages, the gaseous hydrogen can be cooled at required temperature level depending on the vehicle and hydrogen fueling protocol applying to this type of vehicle. Hence, the cooling can be stopped when the hydrogen temperature is reaching a predetermined threshold temperature. When this temperature is reached, the third cooling stage may be by-passed to ensure that energy is not used on cooling the hydrogen further i.e. below requirements of the appropriate fueling protocol.

A hydrogen refueling station cooling system according to any of the paragraphs [0006]-[0067] comprised by a hydrogen refueling system according to any of the paragraphs [0069]-[0090].

In an aspect, the disclosure relates to a method of assembling a high-capacity pipe in pipe heat exchanger, the method comprises the steps of providing: An outer pipe having an inner diameter between 90 mm and 300 mm, two coolant entrances, having an inner diameter of maximum 35 mm, and displaced from the center of said outer pipe and two coolant exits, At least two hydrogen pipe parts having a coiled part and a non-coiled part, A top flange and a bottom flange each having through holes for allowing ends of said at least two hydrogen pipe parts to extent through said top and bottom flange, A center filler, and A compartment separator having a diameter corresponding to said inner diameter, through holes for allowing ends of said at least two hydrogen pipe parts to extent through said compartment separator and a through hole allowing said center filler to extent through said compartment separator. Wherein said method comprises the steps: Mounting said compartment separator inside said outer pipe thereby establishing a first sub-compartment and a second sub-compartment each comprising a set of one coolant entrance and one coolant exit. Mounting and fastening said center filler in the associated through hole of said compartment separator. Mounting a first of said at least two hydrogen pipe parts in the associated through holes of said compartment separator so that the coiled part thereof is comprised by said first sub-compartment and the non-coiled part is at least partly comprised by said second sub-compartment. Mounting a second of said at least two hydrogen pipe parts in the associated through holes of said compartment separator so that the coiled part thereof is comprised by said second sub-compartment and the non-coiled part is at least partly comprised by said first sub-compartment. Mounting said top and bottom flanges, to said outer pipe ensuring that ends of said at least two hydrogen pipe parts are extending through said top and bottom flanges. Fluidly connecting said coolant entrance to a first end of a coolant flow loop. Fluidly connecting said coolant exit to said coolant entrance, and fluidly connecting said coolant exit to a second end of said coolant flow loop.

A hydrogen refueling station according to any of the paragraphs [0006]-[0067], comprising a hydrogen refueling cooling system according to any of the paragraphs [0069]-[0090], wherein at least one heat exchanger is assembled according to the method of paragraph [0092].

According to an embodiment of the disclosure, said first heat exchanger and/or said third heat exchanger is a high-capacity pipe in pipe heat exchanger configured for cooling a pressurized gaseous hydrogen flowing in said hydrogen pipe part.

The disclosure further relates to a use of a heat exchanger for cooling hydrogen, wherein said heat exchanger comprises: at least part of a hydrogen pipe configured for receiving hydrogen; wherein said at least part of a hydrogen pipe is coiled and extending in a longitudinal direction of an inner compartment of said heat exchanger, an outer pipe having an outer side, a coolant side defining said inner compartment with a first diameter, a top flange, a bottom flange and a center filler, wherein said at least part of a hydrogen pipe part is coiled around said center filler, wherein said hydrogen pipe part enters and leaves said inner compartment via said top flange and said bottom flange, wherein said coil is having a second diameter which is less than said first diameter, wherein said outer pipe comprising a coolant entrance and a coolant exit, wherein said coolant entrance enable a coolant to enter said inner compartment in a direction perpendicular to the longitudinal direction of said outer pipe, wherein a coolant pump is configured for introducing said coolant into said inner compartment via said coolant entrance thereby establishing a radial swirling coolant flow in said inner compartment around said center filler towards said coolant exit, wherein said swirling coolant flow is fluidly in contact with said at least part of a hydrogen pipe part and thereby facilitating exchange of heat between said swirling coolant and said received hydrogen flowing in said at least part of a hydrogen pipe part 4a.

The disclosure further relates to a heat exchanger for cooling hydrogen, wherein said heat exchanger comprises: at least part of a hydrogen pipe configured for receiving hydrogen; wherein said at least part of a hydrogen pipe is coiled and extending in a longitudinal direction of an inner compartment of said heat exchanger, an outer pipe having an outer side, a coolant side defining said inner compartment with a first diameter, a top flange, a bottom flange and a center filler, wherein said at least part of a hydrogen pipe part 4a is coiled around said center filler, wherein said hydrogen pipe part enters and leaves said inner compartment via said top flange and said bottom flange, wherein said coil is having a second diameter which is less than said first diameter, wherein said outer pipe comprising a coolant entrance and a coolant exit, wherein said coolant entrance enable a coolant to enter said inner compartment in a direction perpendicular to the longitudinal direction of said outer pipe, wherein a coolant pump is configured for introducing said coolant into said inner compartment via said coolant entrance thereby establishing a radial swirling coolant flow in said inner compartment around said center filler towards said coolant exit, wherein said swirling coolant flow is fluidly in contact with said at least part of a hydrogen pipe part and thereby facilitating exchange of heat between said swirling coolant and said received hydrogen flowing in said at least part of a hydrogen pipe part.

According to an embodiment of the disclosure, said heat exchanger is comprised of said hydrogen refueling station.

According to an embodiment of the disclosure, said heat exchanger is comprised of said hydrogen refueling station cooling system.

According to an embodiment of the disclosure, the center filler is a hollow pipe configured as a coolant exit conduit.

Advantageously, this may have the advantageous effect of increasing the efficiency of the heat exchanger. E.g., this may provide a cyclone flow in the heat exchanger, which may increase the heat exchange between the coolant and hydrogen in the hydrogen pipe, which is advantageous. A coolant exit conduit may be understood as a pipe through which the coolant may exit the inner compartment of the heat exchanger.

According to an embodiment of the disclosure, said hydrogen refueling station cooling system comprises a dry cooler.

According to an embodiment of the disclosure, said inner compartment is separated in two inner sub-compartments by a compartment separator, and wherein each of said sub-compartments comprises a center filler, and wherein each of said center filler of each of said sub-compartments is a hollow pipe configured as a coolant exit conduit.

### BRIEF DESCRIPTION OF THE DRAWINGS

For a more complete understanding of this disclosure, reference is now made to the following brief description, taken in connection with the accompanying drawings and detailed description, wherein like reference numerals represent like parts. The drawings illustrate embodiment of the disclosure and elements of different drawings can be combined within the scope of the disclosure:

FIG. 1a A heat exchanger with solid center filler,

FIG. 1b A heat exchanger with a center filler comprising hydrogen pipes,

FIGS. 2a, 2b Side and Top view of a center filler,

FIG. 3 Top view of a heat exchanger,

FIG. 4 Hydrogen pipes entering a center filler,

FIG. 5 Sectionized heat exchanger,

FIG. 6 Inner compartment of a heat exchanger,

FIG. 7a-7c Cooling system of a hydrogen refueling system,

FIG. 8 Side view of a heat exchanger with a center filler configured as a coolant exit conduit,

FIG. 9 Cross sectional top view of a heat exchanger with a center filler comprising hydrogen pipes and configured as a coolant exit conduit,

FIG. 10 Side view of a sectionized heat exchanger with a center filler configured as a cooling exit conduit,

FIG. 11 Cooling system with a dry cooler,

FIG. 12 Cooling system operated to cool based on a thermal energy storage,

FIG. 13 Cooling system operated to reestablish thermal energy storage.

### DETAILED DESCRIPTION

The present disclosure is described in view of exemplary embodiments only intended to illustrate the principles and implementation of the present disclosure. The skilled person will be able to provide several embodiments within the scope of the claims.

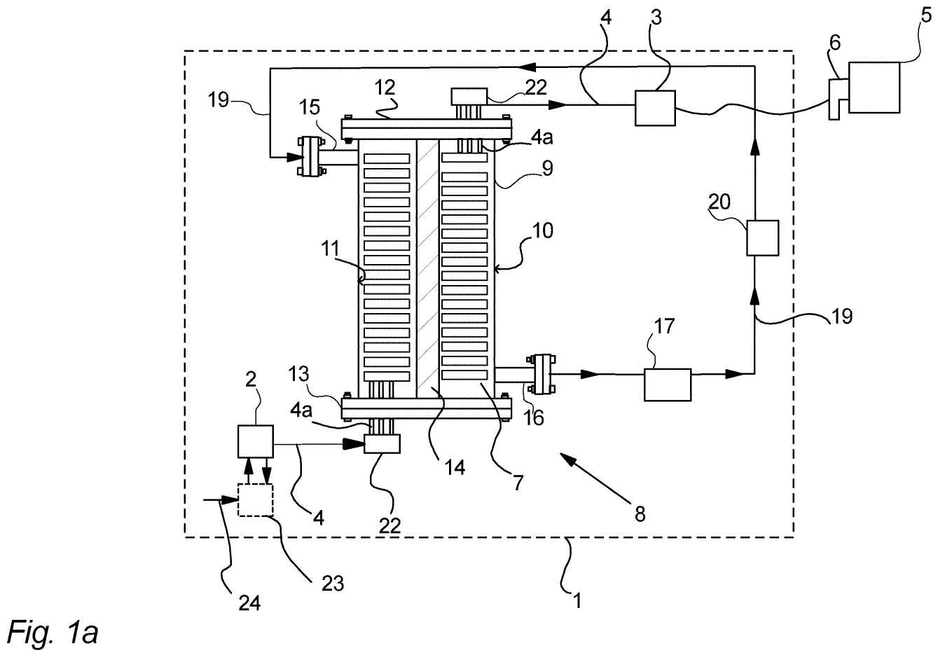

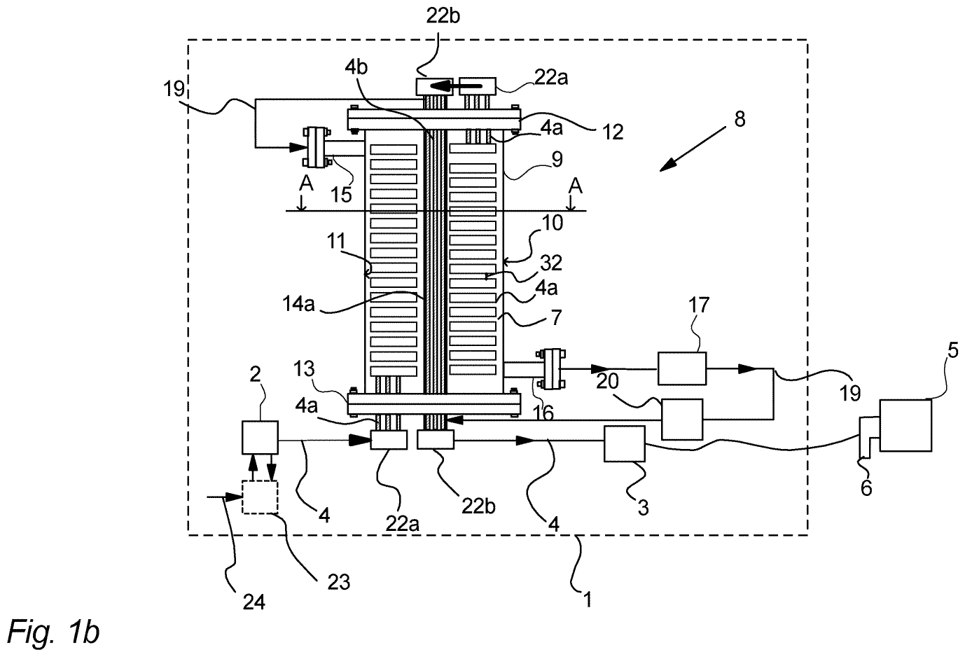

FIG. 1a illustrates an embodiment of the disclosure where the heat exchanger 8 is implemented in a hydrogen refueling station 1. The hydrogen refueling station 1 comprises a hydrogen storage 2 connected to a dispenser 3 via a hydrogen pipe 4 that passes through the heat exchanger 8. The dispenser 3 is connected to a nozzle 6 via a hose. The nozzle is connectable to a receiving vessel 5 of a fuel cell vehicle. The fuel cell vehicle is typically a heavy-duty vehicle having a larger receiving tank volume 5 than light-duty vehicle. The receiving tank system 5 of a heavy-duty vehicle may comprise several individual vessels such as up to 10 or more which together are referred to as the receiving tank (volume) 5. In the art, light-duty vehicles are typically fueled with 5-6 kg of hydrogen. For heavy-duty vehicles this is significantly increased to a level of 65-100 kg or even more which have a significant impact on the cooling requirements toward the cooling system including the heat exchanger.

The hydrogen storage 2 is storing gaseous hydrogen at pressures up to e.g. 100 MPa. Such high pressure is established by a compressor 23 illustrated with dotted lines. The storage 2 may comprise several individual storage vessels (not illustrated) between which the compressor 23 may perform pressure consolidation. Further, a compressor supply pipe 24 is illustrated which is used to provide gaseous hydrogen to the hydrogen refueling station 1, e.g. from a tube trailer, electrolyser, pipeline or the like.

The heat exchanger 8 of the present disclosure thus need to be capable of keeping hydrogen to the receiving vessel at a desired temperature during the entire refueling process. Such refueling process may take up to 15 minutes and the desired temperature of hydrogen in the receiving vessel may be less than 85 °C at the end of the refueling where the pressure of the gas may be between 30 MPa and 50 MPa such as 35 MPa. Other hydrogen refueling station types may supply pressure of gas up or above to 75 MPa.

The illustrated heat exchanger 8 is seen in a side view and has one inner compartment 7. The inner compartment 7 is comprises a center filler 14 connected to a top flange 12 and a bottom flange 13. Around the center filler 14 part of the hydrogen pipe 4a is coiled, i.e. a part of the hydrogen pipe 4a is coiled. Between each turn of the coils of this coiled part is a length referred to as a pitch length. The pitch lengthen should allow heat to be transferred to the coolant and allow flow of coolant between the coils. Hence, the pitch length should be between 1 mm and 30 mm such as between 8 mm and 13 mm, such as 12 mm. In this particular embodiment, the hydrogen pipe 4 enters a manifold 22 at the bottom flange 13. The manifold 22 separates the flow of gaseous hydrogen into, in this particular embodiment, three separate hydrogen pipe parts 4a. These three hydrogen pipe parts 4a enters the inner compartment 7 through the bottom flange 13 and exits the inner compartment 7 through the top flange 12. Here a manifold 22 gathers the three parts of the hydrogen pipe 4a into one single hydrogen pipe 4 again. From this manifold 22, the gaseous hydrogen is conducted to the dispenser 3 and further to the receiving vessel 5. The manifold may have a ration 1:3 to 1:8 i.e. one inlet hydrogen pipe 4/hydrogen pipe part 4a to 3, 4, 5, 6, 7, 8 or more hydrogen pipe parts 4a/additional hydrogen pipes 4b.

The heat exchanger 8 is of the pipe in pipe type i.e. it has an outer pipe 9 with an outer side 10 and a coolant side 11. Through the outer pipe 9 a coolant entrance 15 and a coolant exit 16 is established. As an example, the diameter of the entrance and exit 15, 16 may be 20 mm. These coolants exit and entrance's 15, 16 are connected to each other in a coolant flow loop 19 via a coolant pump 17 and a secondary heat exchanger 20. In this way coolant may be pumped in the loop 19 from exit 16 to entrance 15 via the secondary heat exchanger 20 where its temperature is reduced. As an example, the distance between the entrance 15 and exit 16 may be between 200 mm and 500 mm such as e.g. between 225 mm and 450 mm.

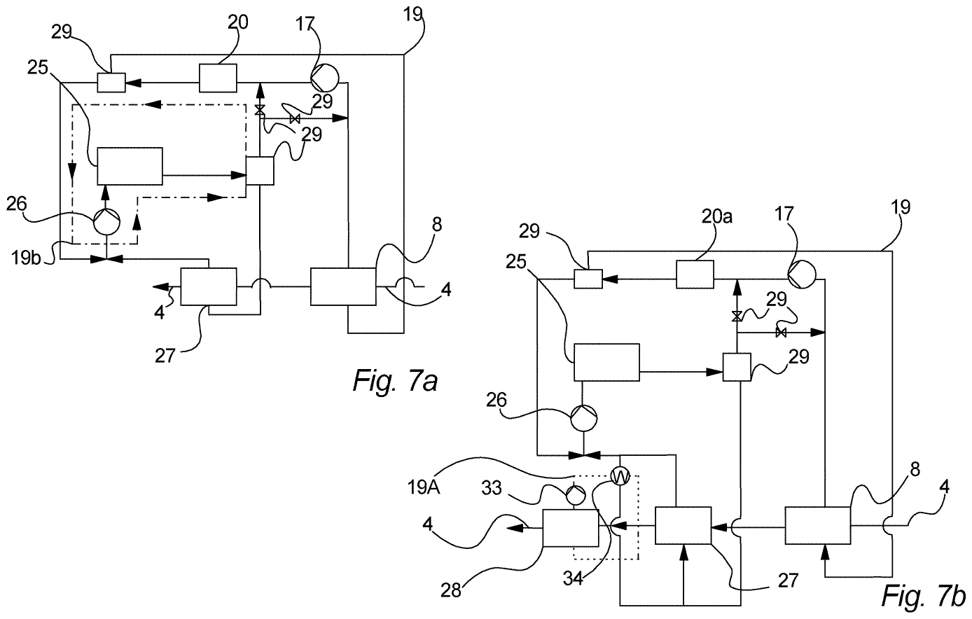

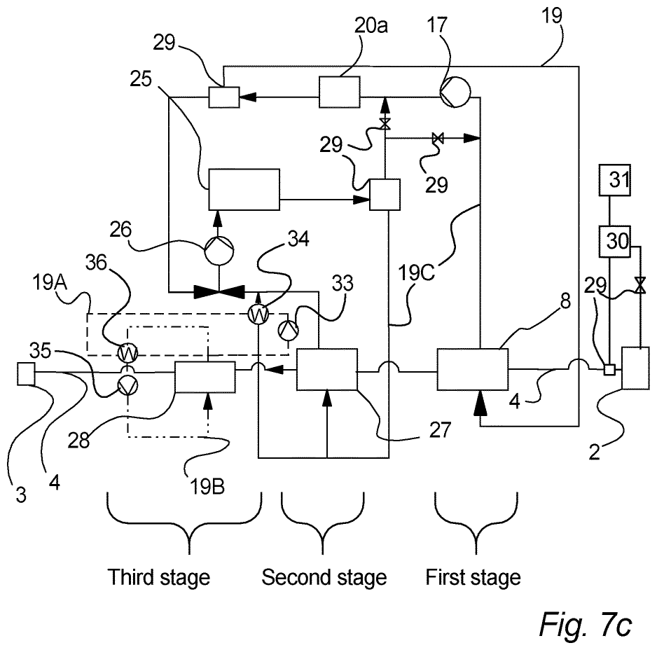

It is preferred that the secondary heat exchanger 20 is located after the pump 17 in that heat introduced to the coolant from the pump may then be cooled. The secondary heat exchanger 20 may be a standard heat exchanger connected to or including a Chiller, a thermal energy storage or similar. In case the secondary heat exchanger 20 is a thermal energy storage 20a, it needs to be established e.g. by a chiller. Such chiller 25 may also be used to cool the coolant which is used in the first heat exchanger 8 in case the cooling capacity of the thermal energy storage is not sufficient such as if it is used, not established, etc. A cooling system including chiller 25 and thermal energy storage 20a is illustrated in FIG. 7a-7c.

The secondary heat exchanger may as mentioned be implemented as a thermal energy storage 20a comprising a phase change material. A phase change material is able to store energy when cooled by the material changing from one phase or state to another such as e.g. from liquid to solid or from gas to liquid. The temperature of the phase change material when it is in a solid state, does not change during cooling, the temperature of the phase change material is first changing as the state of the material is changing e.g. from solid to liquid. Hence, the phase change is activated when the phase change material is cooled or heated, this thermal energy (when cooled) can then subsequently be release to hydrogen that need to be cooled. This energy exchange may be done in one or more heat exchangers as illustrated in FIG. 7a-7c i.e. indirectly or directly if the hydrogen is conducted through the thermal energy storage.

The control of flow and pressure of hydrogen to receiving vessel and cooling system to regulate temperature of the hydrogen is controlled by a controller (not illustrated). The controller may also control coolant to establish the thermal energy storage 20a. This controller may control the flows by controlling various valves based on input from sensors such as temperature, pressure, flow, etc. More specific, the cooling system of FIG. 7a-7c and the state of the phase change material of the thermal energy storage may be controlled by a controller circulating the coolant in the cooling flow loops 19 based on input related to ambient temperature, energy price, energy availability, state of charge of the thermal energy storage, temperature measurement of the hydrogen to be cooled, etc.

Hence, it is possible to inject coolant into the inner compartment substantially perpendicular to the longitudinal axis of the outer pipe 9. Thereby establish a swirling flow of coolant around the center filler 14 from the entrance 15 towards the exit 16.

The swirling flowing coolant is in direct contact with the hydrogen pipe parts 4a extending at least partly in coils inside the inner compartment 7. Thereby cooling of the gaseous hydrogen inside these pipe parts 4a is established and this with an increased gradient of the coolant due to the swirling flow thereof. As an example, if the inner compartment 7 comprise three overlapping coils, the diameter of the inner compartment may be 200 mm.

The swirling effect is established because of a combination of the speed with which the coolant is introduced into the inner compartment, the center filler 14 and the fact that the entrance and exit 15, 16 are established with an offset to the center of the outer pipe (this is illustrated in FIG. 3). Because of the displaced entrance 15, the steam of injected coolant does not directly collide with the center filler 14, but between the coolant side 11 and the center filler 14. The circular nature of the outer pipe 9 guides the coolant into a swirling flow around the center filler 14 towards the exit 16.

The speed with which the coolant is introduced into the inner compartment may be up to 15m/s but need to be balanced with pressure drop which is reduced by reducing the speed. The speed may also be decisive for the diameter of the opening in the coolant entrance 15 which may be up to 50 mm.

The center filler 14 may be made of a plastic material as this is a cheap and light material. However, other types of material may be used.

Beside the effect the center filler 14 has on the establishing of the swirling flow of the coolant, the center filler 14 is also advantageous in that it fills out the dead-volume that otherwise would exists in the center of the inner compartment 7. This dead-volume exists due to the bending radius of the hydrogen pipe part 4a. As an example, the diameter of an inner coil may have a diameter of 88 mm and the center filler 14 may have a diameter of 70 mm.

It should be mentioned that the exit 16 may not necessary be located with an offset to the center nor on the “opposite side” of the outer pipe as illustrated in FIG. 1a. Hence, it may be centered at the outer pipe 9 and on the same straight line perpendicular to the flanges 12, 13 of the outer pipe 9 as the inlet 15.

The flanges 12, 13 may be standard flanges comprising an outer pipe part and a hydrogen pipe part which may be connected by bolts. Similarly, the coolant entrance and exit 15, 16 may be connected to the coolant flow loop 19 via flanges connected by bolts and nuts.

The center filler 14 may e.g. be connected to flanges 12 and 13 via threaded nipple that is screwed into a flange and penetrate the center of the center filler ensuring center position of the center filler (also sometimes referred to as a rod).

The coolant may be a brine such as a mix of water and ethylene.

It should be mentioned that the direction of flow of coolant and/or gaseous hydrogen may be changed compared to what is illustrated in FIG. 1a (and the other figures).

FIG. 1b illustrates the same hydrogen refueling station 1 as illustrated at FIG. 1a with the same heat exchanger 8. The heat exchanger 8 illustrated in FIG. 1b is different only in that the center filler 14 illustrated in FIG. 1a as a solid rod, in FIG. 1b is a hollow center filler 14a. An open center filler 14a is advantageous in that it is also possible to exploit this part of the inner compartment 7 to cool hydrogen. This is possible by letting additional hydrogen pipes 4b extent through the hollow center filler 14a and include the hollow center filler 14a in the coolant flow loop 19.

One way of doing so is by guiding coolant from the secondary heat exchanger 20/coolant flow path 19 into the hollow center filler 14. In FIG. 1b the coolant is introduced in the bottom end and exits at the hollow center filler 14a at the top end. From there the coolant flow loop 19 continues into the coolant entrance 15, through the inner compartment 7 and exits from the coolant exit 16. The pump 17 ensures flow in the loop 19 from the exit 16 to the heat exchanger 20 and round the loop 19 as described.

It should be mentioned that the flow direction in principle could be reversed from the above description, but that it is preferred that the heat exchanger 20 is located downstream the pump 17. Further it should be mentioned that the coolant may be introduced in the hollow center filler 14a from the top or bottom.

The flow of gaseous hydrogen in this embodiment may be going through a first and a second manifold set 22a, 22b if more than one hydrogen pipe part 4a is required inside the inner compartment 7. From the storage 2, hydrogen is conducted in a hydrogen pipe 4 to one manifold of a first manifold set 22a where the gaseous hydrogen is split in e.g. three flow streams one in each of three hydrogen pipe parts 4a. These three flow streams exit the inner compartment 7 at a second manifold of the first manifold set 22a at the top end of the outer pipe 9. From here, the gaseous hydrogen is guided into a manifold of a second manifold set 22b and introduced into the hollow center fille 14a in additional hydrogen pipes 4b. The additional hydrogen pipes 4b ends in a second manifold of the second manifold set 22b and is guided to the dispenser 3 in a hydrogen pipe 4.

It should be mentioned that the second manifold of the first manifold set 22a and the first manifold of the second manifold set 22b may be implemented in one and the same manifold.

The flow of hydrogen is preferred to flow counter current to the direction of flow of coolant so that the hydrogen exiting the heat exchanger meet the coolant entering the heat exchanger and thereby the hydrogen exiting the heat exchanger meet the coldest coolant. Further, it is preferred that when the center filler 14 comprises hydrogen pipes, the cooling therefore in the center filler is the last stage of hydrogen cooling process in the heat exchanger. However, it should be mentioned that the flow of hydrogen may be reversed according to what is described above so that hydrogen first enters the hollow center filler 14a and subsequently the inner compartment 7.

It should be noted that on the inside of the hollow center filler 14a bafflers 21 may be positioned. Introduction of bafflers 21 will lead the coolant from one side in the hollow center filler to the other side of the hollow center filler causing the coolant to cross the hydrogen pipes and thereby enhancing the heat transfer.

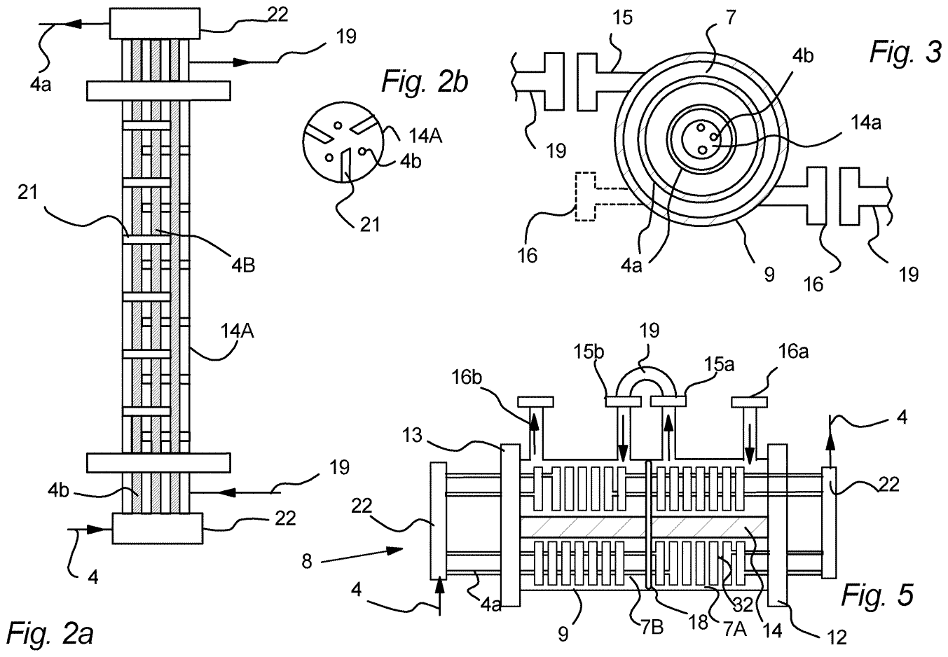

FIG. 2a illustrates a hollow center filler 14a in a side view and FIG. 2b illustrates a hollow center filler 14a in a top view. This particular center filler 14a comprises three additional hydrogen pipes 4b extending between two manifolds 22 connected to a hydrogen pipe 4 in one end and hydrogen pipe parts 4a in the other end. Coolant is introduced and exits as illustrated into the center filler 14a from a pipe of the coolant flow line 19.

In this particular embodiment, the center filler 14a only comprises three additional hydrogen pipes 4b which is illustrated in FIG. 2b. However, nothing prevents to include more additional pipes 4b into the center filler if needed (until physical limitations are reached).

It is noted that a plurality of bafflers 21 are positioned inside the center filler 14a. One example of distribution of bafflers 21 inside the center filler 14a is illustrated in FIGS. 2a and 2b. The distribution is determined so that the bafflers will be crossing the hydrogen pipes to enable flow of coolant crossing or passing the hydrogen pipes as described above.

FIG. 3 illustrates the outer pipe 9 in a top view, cut at line A of FIG. 1b. This particular view comprises three additional pipes 4b in the center filler 14a and two coiled hydrogen pipes 4a in the inner compartment 7.

In this particular embodiment, the coolant entrance and exit 15, 16 are illustrated on “opposite sides” of the outer pipe 9. However, as indicated by the stipulated coolant exit 16, the location of the coolant entrance and exit 15, 16 relative to each other may be different such as “on the same side”.

The entrance and exit 15, 16 are connected to the coolant flow loop 19. One of the entrance and exit is connected so that coolant flows to/from the inner compartment and the other so that coolant flows towards/from the secondary heat exchanger 20. In the embodiment where the center filler is hollow the center filler is included in the coolant flow loop.

FIG. 4 illustrates the top part of a heat exchanger according to an embodiment of the disclosure. It is noted that a manifold 22 is facilitating fluidly communication between a hydrogen pipe 4 and plurality of additional hydrogen pipes 4b. These additional hydrogen pipes 4b are secured in a flange that is connected to the top flange 12 e.g. by means of bolts and nuts (not illustrated). Hence, these additional hydrogen pipes 4b penetrates the top and bottom flange 12, 13 and may be tighten with a fitting screwed into the flange to prevent coolant leakage.

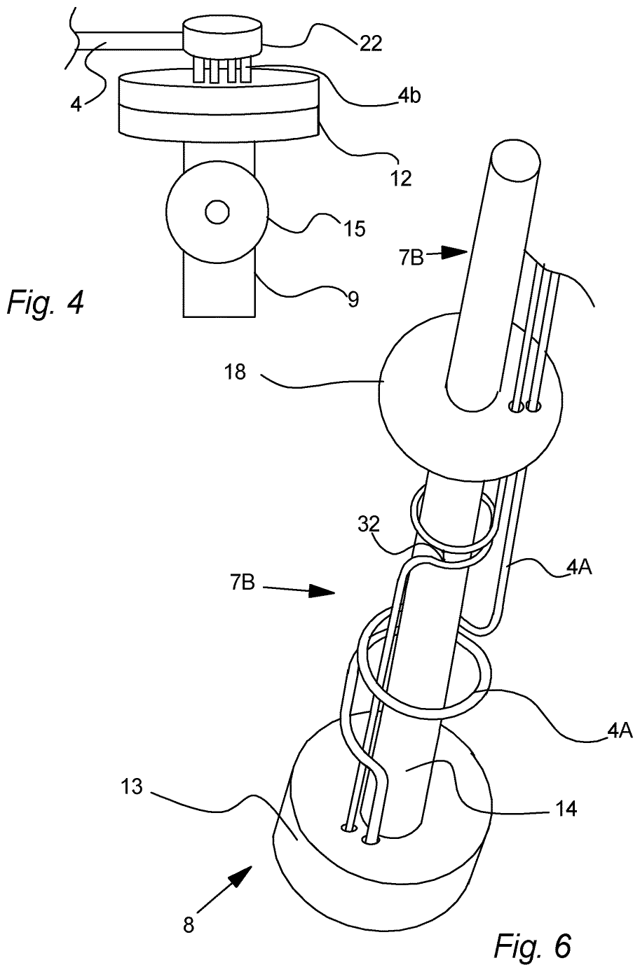

The heat exchanger 8 illustrated in FIG. 5 comprise a center filler 14 implemented at solid rod i.e. with no additional hydrogen pipes 4b inside. The inner compartment 7 is divided in two sub-compartments 7a, 7b be a compartment separator 18. The compartment separator 18 may be of a plastic material having holes through which the center filler 14 and hydrogen pipe parts 4 may extend. The illustrated heat exchanger 8 comprises four hydrogen pipe parts 4 two of which are coiled in the first sub-compartment 7a and passing through the second sub-compartment 7b in a straight line. The last two are coiled in the second sub-compartment 7b and passing through the first sub-compartment 7a in a straight line.

In each of the sub-compartments 7a, 7b the coiled hydrogen pipes are coiled with different diameters (as illustrated in FIGS. 3 and 6.) thereby creating an inner and an outer coil. In this way more surface of the hydrogen pipe parts 4a and thereby more hydrogen can be cooled leading to a higher efficiency of the heat exchanger compared to heat exchangers having the same foot print with different design hydrogen pipes inside the heat exchanger.

As illustrated, both of the sub-compartments 7a. 7b has entrances and exits 15a, 15b, 16a, 16b. This is to be able to re-introduce the coolant and thereby increase the speed of the swirling flow and thereby the efficiency of the heat transfer between coolant and hydrogen pipe part.

As mentioned, the efficiency of the coolant increases with velocity of the swirling speed. The heat rejection to the coolant increases as the coolant flow stream speed is increased, along the hydrogen pipe path. The coolant flow stream speed is induced by the swirling flow of the coolant with high velocity. The swirling speed is higher when the coolant enters the inner compartment 7 compared to the swirling speed after a couple of rounds around the center filler 14. Thus, to be able to reestablish the swirling speed and thereby increase the cooling capacity, the inner compartment may be divided by a compartment separator 18 and the coolant exits the first sub-compartment just above the position of the compartment separator. This to be reintroduced just below the position of the coolant separator.

The heat exchanger 8 illustrated in FIG. 5 comprises two sub-compartments, but more than 2 such as 3, 4 or 5 sub-compartments may be established by two or more compartment separators depending on the length of the outer pipe 9.

The coolant flow path 19 extends through the inner compartment 7 and connects the coolant exit 16a of the first sub-compartment 7a with the coolant entrance 15b of the second sub-compartment 7b.

The compartment separator 18 may comprise several parts such as one part that is fixed or connectable to the center filler 14. On top of such part a disk, sheet or plate constituting the actual separator 18 including holes for the hydrogen pipe parts 4a may be positioned. Such sheet, disk or plate may have a seal at an outer rim facing the coolant side 11 of the outer pipe 9. The friction between such seal and the coolant side may be sufficient to keep the plate positioned. Alternative, the plate may be fastened e.g. by glue to the part attached to the center filler 14.

It should be mentioned that the two-compartment heat exchanger may also be implemented as a connection of two “one-compartment” heat exchangers such as the one illustrated in FIGS. 1a and 1b with a flange on each end. The two “one-compartment” heat exchangers may then be connected to each other with flange connection. In between the two flanges the separator plate 18 may then be mounted so that leakage between the two compartments can be minimized. This embodiment is not illustrated but one can imagen the separator plate 18 fastened between two flanges on the two-compartment embodiment illustrated on FIG. 5.

FIG. 6 illustrates the interior of the heat exchanger 8 illustrated in FIG. 5. Only the coiled hydrogen pipe parts 4a of the first sub-compartment 7a is illustrated and it should be mentioned that for simplicity in the figure no overlap of the coiled hydrogen pipe parts 4a is illustrated. Thus, one should imagen that the entire first sub-compartment 7a between bottom flange 13 and compartment separator 18 comprise overlapping inner and outer coil. Hence, the coils stop just before the bottom flange 13/compartment separator 18 and thus, the straight part of the hydrogen pipe parts 4 is only a few centimetres in the first sub-compartment 7a.

As mentioned above, three or more coiled hydrogen pipe parts may overlap in one sub-compartment. Further as mentioned, there is a distance between the individual “rounds” of the coiled hydrogen pipe parts 4. This distance is referred to as a pitch length 32 and should have a size that allows the coolant to maintain the flow speed as it is swirling round the center filler towards the exit.

The cooling system illustrated in FIG. 7a-c may benefit from the heat exchanger described above with respect FIGS. 1-6. Such cooling system may be a combination of the above-described swirling heat exchanger 8 and secondary heat exchanger 20/thermal energy storage 20a, chiller and additional heat exchanger(s).

It should be noted that the cooling system illustrated in FIG. 7a-7c may be implemented with any type of heat exchangers i.e. not limited to the heat exchanger type described above.

The cooling system illustrated in FIG. 7a comprises a coolant flow loop 19 as illustrated in FIG. 1a and 1b comprising a pump 17 and a secondary heat exchanger 20 circulating a coolant such as a brine. The secondary heat exchanger 20 in this embodiment is a thermal energy storage 20a such as a tank comprising a phase change material that can change phase to a solid state, an aluminium block or similar. If phase change material is used to establish the thermal energy storage such material could be water that is stored in a tank with internal coils where brine can be circulated through the coolant flow loop 19 to reject the heat into the tank absorbed by heat exchanger 8 from hydrogen conducted therethrough in pipes.

Recharging of the thermal energy storage 20a may happen by circulation of a brine in a part of the coolant flow loop 19 which may be referred to as an additional coolant flow loop 19b (stipulated line) that connect the chiller unit 25 with thermal energy storage unit 20a Such thermal energy storage denoted 20a in FIG. 7a-7c may be cooled/established by a brine circulated in the additional coolant flow path 19b pumped through a chiller 25 by a chiller pump 26. A chiller 25 is known in the art as a closed loop refrigeration system using e.g. a coolant such as a low GWP (GWP; Global Warming Potential) refrigerant e.g. <10 such as R717, R290, R600 or R1234Ze or the like and thus does not require any further explanation to be understood as a person skilled in the art.

A cascaded cooling system with thermal energy storage 20a as described above is advantageous to use in a hydrogen refueling station cooling system in that calculations has shown that the up to 9% of compressor energy may be reduced compared with a cooling system without a thermal energy storage. Compared to cooling system using a thermal energy storage in a traditional way e.g. where the thermal energy storage itself is used to cool the hydrogen, a reduction in compressor energy is also proved. Further, where the chiller and thermal energy storage work in parallel and operate at same temperature level, a reduction in compressor energy may also be achieved.

In an embodiment, in the cooling system of the present disclosure, the chiller and the thermal energy storage may work in parallel but operate at different temperature levels. The chiller may e.g. operate at lower temperature than thermal energy storage. A cooling system benefitting from this with two stages is shown in FIG. 7a and a system with three stages as illustrated in FIGS. 7b and 7c. In this way it is possible to push the temperature of second stage down (which may lead to colder hydrogen) and have a reduced load on the chiller, as the first stage is cooled by thermal energy storage.

It should be noted, that, if possible, the thermal energy storage is recharge during night time where there is limited fueling need. Further, recharge during nighttime allows the cooling system to operate at higher efficiency as the ambient temperature is lower than during daytime. Also, the electricity prices level is low during night when recharging.

The cooling system illustrated in FIG. 7a also illustrates a third heat exchanger 27 which may be used as a second cooling stage to reduce the temperature of the hydrogen in the hydrogen pipe 4 further. The third heat exchanger 27 may use the same coolant (e.g. a ethylene glycol water mixture) as the first heat exchanger 8. The first and third heat exchangers 8, 27 may be referred to as brine cooled heat exchangers.

The chiller 25, used to establish the thermal energy storage 20a and cool brine to the first heat exchanger 8, may also be used to cool coolant to the third heat exchanger 27. The flow of such coolant may be controlled by a controller controlling valves 29. Note that more valves than the illustrated may be needed. The valves may be one-, two- or three-way valves.

The cooling system illustrated in FIGS. 7b and 7c are similar to the cooling system illustrated in FIG. 7a except for a fourth heat exchanger 28 providing a third cooling stage to the cooling system. Thereby making it possible for the cooling system to cool the hydrogen to a lower temperature.

The fourth heat exchanger 28 may be connected or implemented in various ways such as those illustrated in FIGS. 7b and 7c.

In 7b a low temperature cooling loop (stipulated lines) 19a circulating a coolant such as R744. The coolant may be circulated by a compressor 33. This low temperature cooling loop 19a includes a heat exchanging unit such as a condenser 34 exchanging heat between the coolant flow loop 19 and the low temperature cooling loop 19a includes the fourth heat exchanger 28. The low temperature cooling loop 19a may also be referred to as a low temperature refrigeration system thus the fourth heat exchanger 28 of the additional coolant flow loop 19b may be referred to as a refrigeration cooled heat exchanger.

In FIG. 7c the heat exchanging unit 34 of the low temperature cooling loop 19a is a liquid-to-liquid chiller/low temperature refrigeration unit. The refrigerant may e.g. be R744 which is compressed round the low temperature cooling loop 19a by a compressor 33.

As mentioned, the low temperature cooling loop 19a comprise or is thermally connected to a heat exchanging unit such as a condenser 34 exchanging heat between the coolant flow loop 19 and the low temperature cooling loop 19a. In this way, the chiller and/or the thermal energy storage 20a is used to cool the coolant of the low temperature cooling loop 19a.

The low temperature cooling loop 19a comprise or is thermally connected to an additional coolant flow loop 19b via a heat exchanging unit such as an evaporator 36 exchanging heat between the low temperature cooling loop 19a and the additional coolant flow loop 19b. The additional coolant flow loop 19b comprises a pump 35 which is circulating coolant in the additional coolant flow loop 19b through the fourth heat exchanger 28 and thereby cooling hydrogen gas flowing therethrough. This coolant can be brine and the heat exchanger 28 can by a brine heat exchanger of same type as heat exchanger 27 and heat exchanger 8.

In both of the implementations pumps 35 or compressors 33 and exchanging units such as condenser or evaporators 34, 36 are needed to facilitate circulation of coolant in the various flow loops and to exchange heat between the various flow of coolant/gas. Various types of heat exchangers or heat exchanging units 34, 36 may be used.

It should be noted that the temperatures, circulation of coolant, conduction of hydrogen, etc. of all embodiments of this document is controlled by one or more controllers (not illustrated) based on predetermined threshold temperatures for hydrogen to be refueled to fuel cell vehicles, input from sensors such as temperature and pressure sensors, expected demand for hydrogen to fuel cell vehicles, information from user interface of dispenser or the like. More specific the flow of coolant in the illustrated coolant flow paths 19 may be controlled by two- or three-way valves 29 (not all illustrated).

Such controller may be a standard industrial controller comprising a data processor and a data storage (or associated data storage). The controller may in an embodiment be the same controller controlling the flow of hydrogen from the hydrogen storage 2, 31 to the dispenser 3 and thereby to the receiving vessel 5. The hydrogen gas flow control may include control of the compressor 30 which may pressurize hydrogen gas from a storage 2 or temporary storage 31 such as from a trailer. Hence, the controller may prepare the cooling system for future cooling of hydrogen to comply with temperature requirements to hydrogen of various fueling protocols.

From the above, it is understood, that generally the first heat exchanger 8 can be used for precooling of hydrogen precool. One example is as mentioned above for cooling hydrogen during refueling of a fuel cell vehicle. Another example is precooling hydrogen delivered to a hydrogen refueling station e.g. in a temporary hydrogen storage 31 such as a trailer. It is advantageous to cool such hydrogen prior to storing it in a hydrogen storage 2 and such cooling may be performed by a cooling system/heat exchanger as described in the present document. This is because typically it is pressurized by a compressor 30 and thereby heated up both at the compressor but also as it is being stored in the hydrogen storage at an increased pressure. Such pressure may be up to 100 Mpa.

The use of a thermal energy storage 20a as illustrated in two and three stage cooling system illustrated in FIGS. 7b and 7c is advantageous in that chiller and thermal energy storage will operate at different temperature level e.g. chiller can operate at lower temperature than thermal energy storage. The thermal energy storage system cool the first stage (including the first heat exchanger 8) and reduce the load on the chiller unit that now can operate at lower temperature and reduce the load on the third cooling stage. Cooling systems with thermal energy storage and a chiller unit used in the art operate at same temperature level corresponding to operation temperature of the thermal energy storage e.g. in case of water used as phase change material around OC. Furthermore, thermal energy storage is typically used to uptake peak cooling load and thereby reduce the load on an associated chiller unit. In this way, such chiller unit can be made smaller and not design for the peak load scenario. As mentioned, in the cooling system of the present disclosure, the thermal energy storage releases chiller cooling capacity thereby more cooling capacity from the chiller 25 can be used for cooling of hydrogen at lower cooling temperature stages 19a, 19b than systems known in the art. The three-stage temperature cascading with thermal energy storage as illustrated in FIGS. 7b and 7c offers lower load on the cooling system with lower power consumption as an outcome. As an example, the total energy Q required for cooling hydrogen to a temperature at minus 20 °C at an ambient temperature of 40 °C and fueling with 10 kg/min will be approx. 160 kW. With present system that utilizes a thermal energy storage and 3 stage cooling the cooling energy covered by low temperature refrigeration unit and chiller unit may be only 76 kW.

Furthermore, the control of the illustrated cooling system may be combined with a control strategy that is accommodated to operate with smart grid, i.e. the thermal energy storage may be regenerated when energy prices/demand is low, and/or when ambient conditions are favourable. Accordingly, the thermal energy storage may be recovered by use of weather (ambient temperature) energy price, required cooling capacity demand forecast, etc. Hence, the illustrated cooling system may be controlled by a controller circulating the coolant in the cooling flow loops 19 based on input related to ambient temperature, energy price, energy availability, state of charge of the thermal energy storage, temperature measurement of the hydrogen to be cooled, etc.

The cooling of hydrogen at the second stage i.e. at the third heat exchanger denoted 27 (directly with chiller) can be dependent on ambient temperature i.e. when ambient temperature (during day) is low the chiller 25 operates more efficiently as it does not have to operate at high temperature difference between condensing and evaporating temperature i.e. the coefficient of performance (efficiency) of the second stage is in this situation improved. In this situation, it is possible to operate this second stage at a lower temperature which will result in a reduction of the heat load on the third stage (at the fourth heat exchanger denoted 28) and further improve efficiency of the illustrated cooling system. Hence, the second stage cooling temperature may be ambient temperature dependent and controlled to operate at the highest system efficiency.

Depending on the vehicle and fueling protocol the third cooling stage can be bypassed. If a brine heat exchanger is used at the third cooling stage, the pump can be turned off i.e. no circulation of the brine in the low temperature cooling loop 19a and thereby no heat removal from the brine in the heat exchanger 28 of the third stage. Hence, a reduction of load on the third stage is obtained simply by controlling the pump (turning it off) and thereby a reduction in power consumption of the cooling system is achieved.

Accordingly, such hydrogen precool system may comprise one or more stages where the hydrogen is cooled by one or more heat exchangers. Such heat exchanges may be implemented as the high-capacity pipe in pipe heat exchanger 8 as described above. The different heat exchangers are operating at different temperature level. More cooling stages may be introduced to raise the efficiency of the cooling system. Below is an example of implementation of a three-stage cooling system.

In the first stage, the hydrogen may be cooled from ambient temperature of the hydrogen storage 2 down to 10 °C, preferably down to 5 °C and most preferably down to 0 °C. In the second stage, the hydrogen may be cooled further down from this temperature to minus 5 °C, preferably down to minus 10 °C, most preferably down to minus 15 °C. In the third stage the hydrogen may be cooled down to minus 40 °C, preferably down to minus 30 °C, most preferably down to minus 20 °C. In one embodiment, the first, second and third cooling stage may cool by a high-capacity pipe in pipe heat exchanger or a different type of heat exchanger where coolants are used. Further phase shift of the coolant may occur, but preferably not in the heat exchangers cooling the hydrogen. Preferably a phase shift is happening in a thermal energy storage 20a such as illustrated in FIG. 7a-7c.

The first stage heat exchanger 8 may be coupled to a coolant pump 17 that circulates the brine (coolant) through the high-capacity heat exchanger 8 cooling the hydrogen and rejecting the heat to a secondary heat exchanger 20 which may be implemented as a thermal energy storage 20a unit with an solid state cooling bank such as an ice bank.

The second stage heat exchanger 27 may be coupled to a chiller pump 26 that circulates the brine (coolant) through the high-capacity heat exchanger 27 cooling the hydrogen and rejecting the heat in a chiller unit 25.

The third stage heat exchanger 28 may be coupled to a pump 33 that circul ates the brine through the high-capacity heat exchanger 28 cooling the hydrogen and rejecting the heat into a low temperature cooling loop 19a that operates as a cooling circuit with the chiller 25.

Accordingly, during refueling of a receiving vessel, the coolant pump 17 circulates the brine through thermal energy storage 20a and through the first heat exchanger 8 thereby cooling the hydrogen in the first heat exchanger 8. The hydrogen temperature at the outlet of the first heat exchanger 8 may be around 5 °C. Thus, the hydrogen temperature may be approximate 5 °C when entering the third heat exchanger 27.

The chiller pump 26 circulates the brine through the chiller 25 and establish a flow of brine towards the third heat exchanger 27 and the condenser (also referred to as heat exchanging unit) of the low temperature cooling loop 19a. The hydrogen temperature at the outlet of the third heat exchanger 27 may be around minus 10 °C.

The low temperature cooling loop 19a (also referred to as low temperature refrigeration system) is then able to cool the hydrogen down to its final temperature which may be minus 20 °C, minus 25 °C, minus 30 °C, minus 40 °C or other temperatures therebetween. However, the load on low temperature cooling loop 19a is significantly reduced as the temperature of the entering hydrogen is around minus 10 °C. The load is reduce compared to other known cooling systems for hydrogen refueling stations.

During times when there is less refueling activity such as during nighttime the thermal energy storage can be regenerated. The regeneration may be performed by stopping the coolant pump 17 and starting the chiller pump 26. As described above brine is circulated in the additional coolant flow loop 19b i.e. over the over the chiller unit 25 and toward the thermal energy storage 20a. After having passed through the secondary heat exchanger 20 comprising the thermal energy storage 20a, the brine returns to the suction side of the chiller pump 25.

In an embodiment, where the precool temperature of the hydrogen is high such as above minus 10 °C (T10 and above T_H2>=−10 C in the SAE-J2601 fueling protocol standard terminology) the low temperature cooling loop 19a may not be needed in the cooling system. In this embodiment, the cooling of the hydrogen happens by using the cooling storage of the thermal energy storage and the chiller unit 25. Furthermore, in such embodiment, there may be no need of a refrigeration cooled heat exchanger i.e. the fourth heat exchanger 28, that is more expensive and more exposed to potential leakage of the refrigerant.

As mentioned, the above-described cooling system is flexible in that it can cool hydrogen in different steps and by different cooling sources (chiller or thermal energy storage). This is an advantageous e.g. when the hydrogen refueling station is operated in warm ambient temperatures such as around 40 °C.

As an example, when the hydrogen refueling station is operated up to a temperature of 40 °C, the cooling system, during refueling, may be operated as two independent cooling systems. This should be understood as the first stage i.e. the first heat exchanger 8 is using brine circulated between the thermal energy storage 20a and the first heat exchanger 8 by the coolant pump 17 to cool the hydrogen conducted through the first heat exchanger 8. At the same time, the second and third cooling stages are benefitting from brine circulated between the third heat exchanger 27, the low temperature cooling loop 19a and the chiller 25 by the chiller pump 26.

Again, as an example, during periods with no refueling and temperatures below 40 °C, the thermal energy storage 20a may be re-established by circulation of brine in the additional coolant flow loop 19b illustrated with dotted lines in FIG. 7a.

Again, as an example, during fueling in ambient temperatures above 40 °C, the chiller 25 may no be able to assist in cooling the brine. However, the hydrogen refueling station would still be able to cool hydrogen for fueling. One way of obtaining this is to not use the first stage and instead cool brine for the second and third stages from the thermal energy storage 20a. The brine may be circulated from the condenser of the low temperature cooling loop 19a/third heat exchanger 27 to the thermal energy storage 20a by the coolant pump 17.

Again, as an example, during fueling in ambient temperatures below 40 °C if there are no more stored energy in the thermal energy storage 20a, the second and third cooling stages may be operated by circulating, by the chiller pump 26, coolant through the chiller 25 and to the third heat exchanger 27 and to the low temperature cooling loop 19a.

The flow of coolant in these examples may be controlled by opening and closing the relevant valves 29.

The thermal energy storage 20a may be regenerated when energy prices are low, and/or when ambient conditions are favourable. Thus, the controller controlling the regeneration may use weather/energy price forecast as input to determine when to recharge the thermal energy storage.

Cooling of the second stage may be ambient temperature dependent i.e. when ambient temperature is reduced the coefficient of performance of the first cooling stage is improved and it is possible to operate this stage at a lower temperature i.e. reduce the heat load on the third cooling stage.

Depending on the vehicle and fueling protocol third cooling stage can be bypassed, if the pump circulating brine in the additional coolant flow loop 19b of FIG. 7c can be turned off leading to no circulation of brine and thus no heat removal from the fourth heat exchanger 28.

In order to boost the chiller performance, the cooling system of FIG. 7b or 7c and more specifically, the chiller 25 may by slightly modified. An extra plate heat exchanger (not illustrated) can be mounted after the condenser of the chiller. Such extra plate heat exchanger may be included in the coolant flow loop 19 from the output of the thermal heat exchanger 20a and connected to the coolant flow loop lines denoted 19c on FIG. 7c. In this configuration the original condenser of the chiller will work as a gas cooler (cooling the high discharge temperature) and the new plate heat exchanger will then be a condenser. Brine temperature supplied by the coolant pump 17 over the thermal energy storage 20a is cooled to reduce the condensing temperature of the chiller 25 to below ambient conditions which significantly is improving its performance.

For a Carbon Dioxide based chiller that operates above the critical point/temperature of the Carbon Dioxide, the plate heat exchanger is an additional gas cooler.

In both cases the cooling capacity supplied by thermal energy storage 20a to the chiller 25 will be utilized at lower temperature level in heat exchangers for cooling of hydrogen.

This modification will lead to a higher load and higher storage requirements toward secondary heat exchanger i.e. the thermal energy storage unit. This modification however allow the chiller 25 to operate at high ambient temperature such as above 40 °C.

As an example, with such modification, operation of the hydrogen refueling station in ambient temperatures above 40 °C, is possible. Brine cooled by the thermal energy storage 20a is split between one path of the coolant flow loop 19 to the first heat exchanger 8 and one path to the plate heat exchanger associated with the chiller 25. Thus, this brine is both used to cool hydrogen in the first cooling stage and assist the chiller 25 in cooling bring to the second and/or third cooling stage.

From the above it is now clear that the disclosure relates to a refueling station having a cooling system comprising a heat exchanger. In an embodiment the heat exchanger is establishing a swirling flow of coolant through heat exchanger for cooling hydrogen conducted in hydrogen pipes inside said heat exchanger. The cooling system may comprise several cooling stages benefitting from two or more heat exchangers (one of which may be a swirling heat exchanger) and a thermal energy storage. Such cooling system is advantageous in that it increases the cooling capacity and thereby facilitates faster refueling of receiving vessels having larger volumes than known cooling systems facilitates.

The cooling system described above, is advantageous in that it is possible to use the chiller 25 to cool brine and thereby cool hydrogen further down in the second cooling stage and use the brine in the cascade low temperature cooling loop 19a to cool hydrogen in the third cooling stage to its final dispensing temperature. The chiller 25 is thus used for cooling hydrogen of the second and third cooling stages simultaneously with cooling hydrogen at the first cooling stage based on the thermal energy storage 20a. The three-stage temperature cascading with thermal energy storage offers a lower load on the cooling system resulting in a lower power consumption compared to known cooling systems for hydrogen refueling stations.

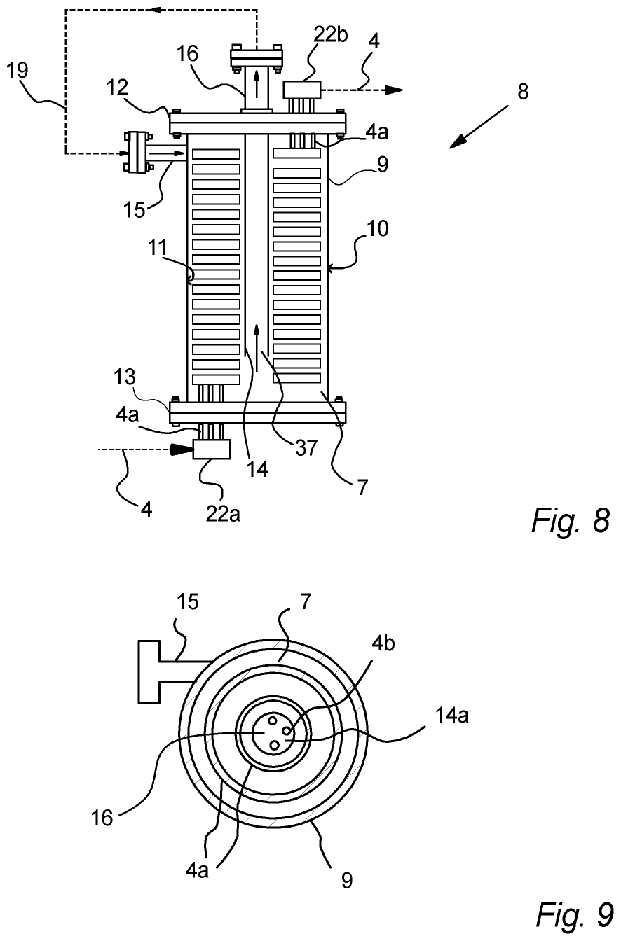

FIG. 8 illustrates a side view of a heat exchanger comprising a hollow center filler configured as a coolant exit conduit, according to an embodiment of the disclosure. Like other heat exchangers embodiments of the disclosure, including, e.g., the heat exchangers illustrated in FIG. 1a, FIG. 1b, FIG. 2a FIG. 2b, and FIG. 5, the heat exchanger illustrated in FIG. 8 may be implemented in a hydrogen refueling station and/or in cooling systems, e.g., cooling systems of a hydrogen refueling station, including the systems illustrated in FIGS. 7a-7c. Hence, the heat exchanger may be implemented to cool hydrogen and/or implemented to provide cooling in cooling systems, e.g., including cooling of a coolant and/or for cooling of a thermal energy storage, including the thermal energy storage of various cooling systems of the disclosure. Furthermore, the heat exchanger illustrated in FIG. 8 and other embodied heat exchangers of the disclosure may also be used to evaporate liquids, e.g., including liquid hydrogen. Hence, the heat exchangers may be implemented to evaporate liquid hydrogen in hydrogen refueling stations using a liquid hydrogen supply.

The heat 8 exchanger illustrated in FIG. 8 is similar to the heat exchanger illustrated in FIG. 1a. However, the heat exchanger 8 illustrated in FIG. 8 comprises a hollow center filler 14 with a center filler inlet 37 and coolant exit 16 and the center filler thereby being configured to conduct coolant via the center filler inlet 37 from the one end of the inner compartment 7 relatively close to the bottom flange 13 and out through the coolant exit 16 near the top flange 12 of the heat exchanger 8. This arrangement may advantageously provide a more efficient heat exchange between the coolant and the hydrogen in the hydrogen pipe. Advantageously, this arrangement may further establish a cyclone flow of the coolant inside the inner compartment 7 when the coolant is sucked out from the bottom of the inner compartment via the center filler inlet 37 through the coolant exit 16 via the center filler 14. The cyclone effect may provide more efficient heat exchange between hydrogen flowing closer to the center filler. This may advantageously provide a more efficient heat exchanger. Notice that the distance between the bottom of the inner compartment (e.g., at the bottom flange 13) and the center filler inlet 37 may vary across different implementations of the heat exchanger 8. E.g., the distance between the inner compartment and the center filler inlet may be at least 50% of the length of the inner compartment, such as at least 60% of the length of the inner compartment, such as at least 70% of the length of the inner compartment such as at least 80% of the length of the inner compartment, such as at least 90% of the length of the inner compartment, such as at least 95% of the length of the inner compartment. E.g., the distance from the bottom of the inner compartment to the center filler inlet may be at least 5 cm., such as at least 10 cm., such as at least 20 cm., such as at least 30 cm., such as at leat 40 cm. such as at least 50 cm. Notice that these mentioned distances may depend on the size of the heat exchanger and/or of the length of the inner compartment of the heat exchanger. Therefore the lengths may be larger or smaller than the mentioned ranges, according to embodiments of the disclosure.

The heat exchanger 8 comprises an inner compartment 7 delimited by a top flange 12, a bottom flange 13 and by the wall of the outer pipe 9. The inner compartment 7 comprises a center filler 14 connected to the top flange 12 and extending towards the bottom flange. In this embodiment, the center filler 14 is a hollow pipe with a center filler inlet positioned at the part of the center filler 14 located closest to the bottom flange 13 and with another pipe opening, a coolant exit 16, located in the other end of the center filler 14 near the top flange 16. Around the center filler 14, part of the hydrogen pipe 4a is coiled, e.g., a part of the hydrogen pipe 4a is coiled. In this particular embodiment, the hydrogen pipe 4 enters a first manifold set 22a at the bottom flange 13. The first manifold set 22a separates the flow of hydrogen into, in this particular embodiment, three separate hydrogen pipe parts 4a. These three hydrogen pipe parts 4a enters the inner compartment 7 through the bottom flange 13 and exits the inner compartment 7 through the top flange 12. Here a second manifold set 22b gathers the three parts of the hydrogen pipe 4a into one single hydrogen pipe 4 again.

When implementing the heat exchanger 8 in a hydrogen station, hydrogen may be conducted to a dispenser (not illustrated) from this second manifold set 22b, and further to a receiving vessel (not illustrated).

The heat exchanger 8 is of the pipe in pipe type, with the outer pipe 9 having an outer side 10 and a coolant side 11. Through the outer pipe 9 a coolant entrance 15 and a coolant exit 16 is established. In this embodiment, coolant enters the inner compartment via the first manifold section 22a, then flows towards the bottom flange in a swirling coolant flow before it enters inside the hollow center filler 14 via the center filler inlet 37 to flow out through the coolant exit 16. As an example, the diameter of the entrance, exit and of the center filler 15, 16, 14 may be 20 mm. These coolants exit and entrance's 15, 16 may be connected in various ways, e.g., connected to each other in an optional coolant flow loop 19. This loop may optionally comprise a coolant pump (not illustrated) and a secondary heat exchanger (not illustrated). If the heat exchanger is implemented in this way, coolant may be pumped in the loop 19 from exit 16 to entrance 15 via, e.g., the secondary heat exchanger (not illustrated) where its temperature is reduced. As an example, the distance between the entrance 15 and exit 16 may be between 200 mm and 500 mm such as e.g. between 225 mm and 450 mm. Notice that this distance may be larger or smaller. E.g., if the heat exchanger is implemented as a sectionized heat exchanger, the distance between the entrance and exit may be even larger than the mentioned ranges.

The various embodied heat exchangers of the disclosure have been illustrated as standing upright with the top flange on top and the bottom flange at the bottom (towards the ground). However, the heat exchangers may be positioned differently according to embodiments of the disclosure. E.g., the heat exchangers may lie down or be positioned in different angles with respect to the ground. E.g., it may be advantageous to position the heat exchanges so that the center filler is substantially parallel with the ground (heat exchanger lying down), as this provides less strain on components such as, e.g., the center filler top flange, and fastening means (screws, bolts, nits, welts etc.) for fixing the center filler and other pipes.

FIG. 9 illustrates a schematical cross sectional top view of an outer pipe 9 of a heat exchanger with a center filler configured as a coolant exit conduit, cut at a position corresponding to the illustrated line A in FIG. 1b. Such heat exchanger with a center filler comprising a coolant exit conduit is illustrated in FIG. 8. In addition to the heat exchanger illustrated in FIG. 8, the outer pipe 9 illustrated in FIG. 9 further comprises three additional pipes 4b arranged inside the center filler 14a and two coiled hydrogen pipes 4a arranged in the inner compartment 7. This arrangement with additional hydrogen pipes 4b inside the center filler is, e.g., illustrated in FIG. 1b.

In this embodiment of the disclosure, the coolant exit is not positioned on the side of the outer pipe, as in, e.g., the embodiment illustrated in FIG. 3. Instead, the center filler 14a is hollow and function as a coolant exit conduit as illustrated in FIG. 8. Hence, FIG. 9 illustrates an embodiment combining a center filler that functions as a coolant exit conduit (see, e.g. FIG. 8), with embodiments having additional hydrogen pipes 4b arranged inside the hollow center filler 14a (see, e.g., FIG. 1b and FIG. 2). This arrangement may, advantageously, provide an efficient heat exchanger.

The entrance and exit 15, 16 are connectable to a coolant flow loop (not illustrated). The coolant flow loop is illustrated in various other embodiments of the disclosure. One of the entrance and exit is connected so that coolant flows to/from the inner compartment and the other so that coolant flows towards/from the secondary heat exchanger 20. In the embodiment where the center filler is hollow the center filler is included in the coolant flow loop.

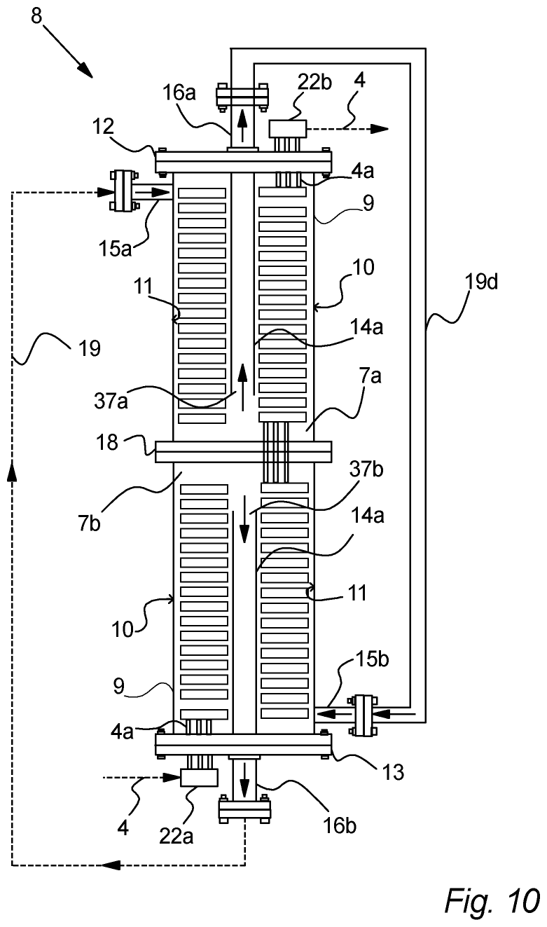

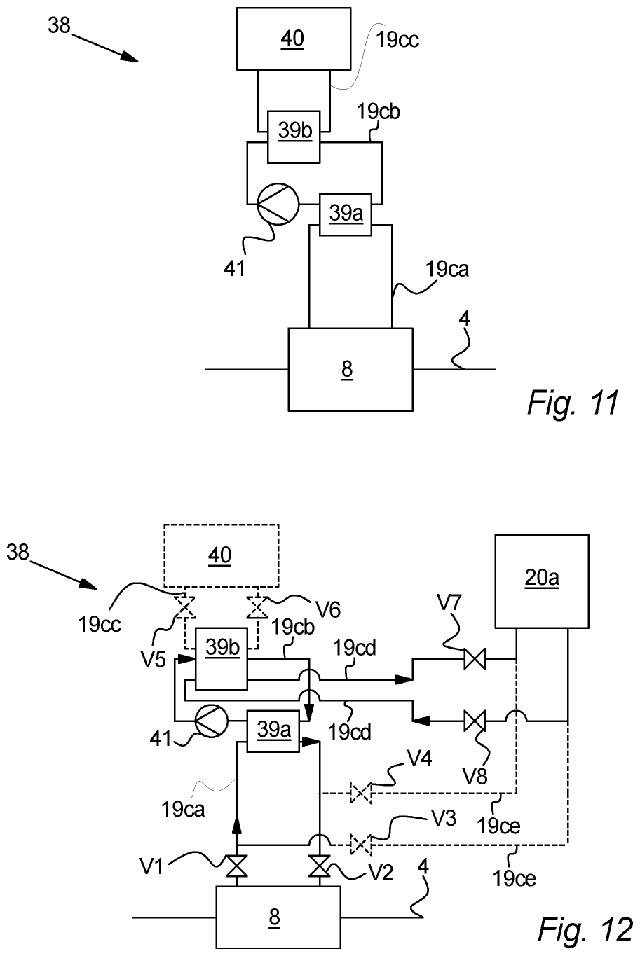

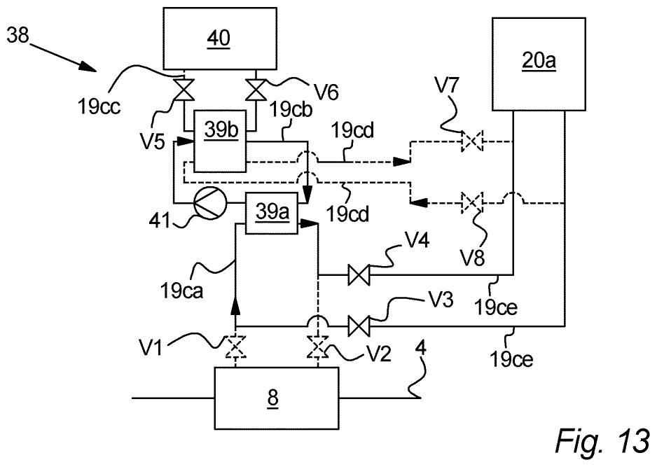

FIG. 10 illustrates a schematical representation of a sectionized heat exchanger comprising two sub-compartments 7a, 7b, and wherein each sub-compartment of the heat exchanger comprises a hollow center filler 14a, according to an embodiment of the disclosure. Each hollow center filler 14a being configured as a coolant exit conduit comprising a coolant exit 16, and a center filler inlet 37. The illustrated heat exchanger 8 combines the principles of the heat exchanger with a hollow center filler configured as coolant exit conduit illustrated in FIG. 8, with the principles of the sectionized heat exchange illustrated in FIG. 5. This has the advantage of providing a sectionized heat exchanger with improved efficiency. The heat exchanger may be implemented in a cooling system according to various embodiments of the disclosure, and may be implemented in a hydrogen refueling station to cool hydrogen according to various embodiments of the disclosure. These cooling systems include, e.g., the cooling systems illustrated in FIG. 7a, FIG. 7b, FIG. 11, FIG. 12 and FIG. 13.

In addition to the non-sectionized heat exchangers illustrated in, e.g., FIG. 1a, 1b and FIG. 8,the sectionized heat exchanger 8 illustrated in FIG. 10 comprises a compartment separator 18 that separates the inner compartment 7 into two sub-compartments 7a, 7b. The compartment separator 18 may be of a plastic material having holes through which the hydrogen pipe parts 4 may extend from one inner sub-compartment to the other inner sub-compartment. The compartment separator may also be made of other materials, including, e.g., metal, ceramic materials or composite materials comprising more than one material. The illustrated heat exchanger 8 comprises hydrogen pipe parts 4, which are coiled in the first sub-compartment 7a and passing through the second sub-compartment 7b in a straight line and hydrogen pipes that are coiled in the second sub-compartment 7b and passing through the first sub-compartment 7a in a straight line. The hydrogen pipes may also follow a different geometry than the mentioned coil geometry. Typically, it is most efficient to utilize a geometry that provides a large contact area between the hydrogen pipes and the coolant.

As illustrated, both of the sub-compartments 7a, 7b has cooling entrances 15a, 15b and exits 16a, 16b. The coolant enters the first sub-compartment of the heat exchanger via the first cooling entrance 15a arranged at the side of the heat exchanger, substantially perpendicular to the longitudinal direction of the heat exchanger, and thereby creates a swirling flow in the first sub-compartment. The coolant flows in a swirling flow towards the compartment separator 18. A suction is created in the hollow center filler 14a, which functions as a coolant exit conduit, and thereby the coolant flows into the hollow center in filler via a first center filler inlet 37a. with a dominant flow direction going in a direction towards the first center filler inlet 37a. The suction in the center filler creates a cyclone flow, which may be characterized by a further swirling flow or vortex flow of coolant that may flow inside the swirling flow in a direction toward the center filler inlet 37. Advantageously, this provide better heat exchange with the hydrogen in the hydrogen pipes 4a located in proximity to this further vortex flow of coolant. Altogether providing a more efficient heat exchanger. The coolant exits the first sub-compartment 7a via the first coolant exit 16a and flows via a second coolant flow loop 19d into the bottom of the second sub-compartment 7b via the second coolant entrance 15b. The second coolant entrance 15b is arranged at the side of the second inner compartment 7b near the bottom flange 13 and substantially perpendicular to the longitudinal direction of the second sub-compartment 7b, and thereby creates a swirling flow of coolant in the second sub-compartment 7b. The coolant flows in a swirling flow towards the compartment separator 18. A suction is created in the second hollow center filler 14b, which functions as a coolant exit conduit, and thereby the coolant flows into the second hollow center filler via a second center filler inlet 37b. with a dominant flow direction going in a direction toward the second center filler inlet 37b. The suction in the second center filler creates a cyclone flow. The cyclone flow may be characterized by a further swirling flow or vortex flow of coolant that may flow inside the swirling flow in a direction toward the second center filler inlet 37b. This creates the same advantages as mentioned in regards to the first sub-compartment 7a, e.g. a more efficient heat exchange. The coolant leaves the second sub-compartment 7b via the second hollow center filler 14b and via the second coolant exit 16b.

Optionally, the second cooling exit may be coupled to the first cooling entrance 15a via a coolant flow loop 19. The coolant flow loop may comprise a secondary heat exchanger configured to cool the coolant before it enters at the first coolant entrance 15a.

Optionally, the sectionized heat exchanger may be used to heat liquid hydrogen in the hydrogen pipe 4, 4a. In this optional case, the coolant flow loop 19 may comprise a heat exchanger utilized for heating the coolant. Batch heating may be used for heating the hydrogen, by having the hydrogen staying in the hydrogen pipes in a time period before letting the hydrogen out. In batch heating hydrogen is trapped for a time period inside the heat exchanger in the hydrogen pipes, e.g., by closing pipes at the entrance and exit of the hydrogen pipes. The time period may be varied depending on how long it takes to heat the hydrogen and depending on the target temperature that the hydrogen should be heated to. After the time period, the hydrogen is let out of the hydrogen pipes and further hydrogen is allowed into the heat exchanger for heating. The heating process may also be carried during continuous flow of hydrogen through the heat exchanger. Furthermore, any of the heat exchangers of the disclosure may be utilized for heating of hydrogen, following the same or a similar process as the one described here.

The heat exchangers may as the other heat exchangers of the disclosure, be arranged in any position, e.g., with respect to the ground. E.g., the heat exchanger may be positioned such that it stands upright, is lying down or is positioned at angle with respect to the ground. The positioning/orientation of the heat exchanger may depend on the implementation of the heat exchanger, e.g., the implementation in existing cooling systems or new cooling system designs.

Optionally, in each sub-compartment 7a, 7b, the coiled hydrogen pipes may be coiled with different diameters. Advantageously, this may create an inner and an outer coil. In this way, more surface of the hydrogen pipe parts 4a and thereby more hydrogen can be cooled leading to a higher efficiency of the heat exchanger compared to heat exchangers having the same foot print with different design hydrogen pipes inside the heat exchanger. This is illustrated in, e.g., FIG. 3 and FIG. 6.

FIG. 11 illustrates a schematical representation of a cooling system 38 with a dry cooler 40 according to an embodiment of the disclosure. The cooling system may be utilized to cool hydrogen independent of other cooling systems or other cooling system stages. However, the cooling system may also be implemented as a cooling stages in a cooling system comprising a plurality of cooling stages. An example of a cooling system comprising a plurality of stages is illustrated in FIG. 7b and the first, second and third stages of FIG. 7c. E.g., the skilled person would appreciate the similarity between this cooling system and stage 2 of the cooling system illustrated in FIG. 7c. Notice however that the cooling system illustrated in FIG. 11 comprises a chiller that exploits a dry cooler 40 for cooling. The dry cooler enables this cooling system to provide sufficient cooling for cooling hydrogen during a refueling in surroundings where the temperature may reache at least 40 degrees Celsius. Nevertheless, this cooling system may typically be implemented for cooling when the surrounding (ambient temperature) is below 40 degrees Celsius or the cooling system may be utilized as a cooling stage in a multi stage cooling system comprising further cooling stages. Combining a plurality of cooling stages may advantageously provide sufficient cooling of hydrogen during a refueling even in hot climate where the surrounding temperature may reach 40 degress Celsius or more.

Notice that in the figure, standard components of cooling loops including, e.g., compressors, pumps, controllers and valves are not illustrated or described, so as to not clutter the figures with unnecessary details that may obscure the concept of the disclosure.

The cooling system 38 comprises a heat exchanger configured for cooling hydrogen passing through the heat exchanger 8 via the hydrogen pipe 4 that goes through the heat exchanger. Examples of the heat exchanger 8 includes, e.g., the heat exchangers illustrated in FIG. 1a, FIG. 1b, FIG. 5, FIG. 8, FIG. 9, and FIG. 10.

The cooling system further comprises a first cooling loop, a second cooling loop and a third cooling loop. The first cooling loop comprises a first flow loop line 19ca that fluidly connects the heat exchanger 8 and a first supplementary heat exchanger 39a. The second cooling loop comprises a second flow loop line 19cb that fluidly connects the first supplementary heat exchanger 39a, a cooling loop compressor 41 and second supplementary heat exchanger 39b. The third cooling loop comprises a third flow loop line 19cc that fluidly connects the second supplementary heat exchanger 39b and the dry cooler 40. The dry cooler cools the coolant flowing in third flow cooling loop and thereby provides further cooling to the second cooling loop, via the second supplementary heat exchanger 39b. Advantageously, adding the dry cooler 40 to the cooling system may increase the cooling capacity of the cooling system such that the cooling capacity of the system is larger compared to the cooling capacity provided by only the second cooling loop without the dry cooler added. The first supplementary heat exchanger cools the coolant flowing in the first cooling loop, and thereby the first cooling loop cools hydrogen in the hydrogen pipe 4 via the heat exchanger 8. This system may substantially correspond to a part of the second stage of the cooling system illustrated in FIG. 7c comprising the chiller unit 25, but with a dry cooler added to increase the cooling capacity of the second stage and with no thermal energy storage added.

Optionally, the cooling system may be used in a standalone configuration wherein the cooling system may utilize different types of heat exchangers. Hence the cooling system is not limited to the use of the heat exchangers illustrated in, e.g., FIG. 1b, FIG. 1a, FIG. 5, FIG. 8 and FIG. 9.

FIG. 12 illustrates a schematical representation of a cooling system 38 with a thermal energy storage 20a according to an embodiment of the disclosure. The cooling system 38 is similar to the cooling system illustrated in FIG. 11, with the exception that this system comprises a thermal energy storage 20a that may be used for cooling, e.g., during hot ambient temperatures at which the cooling system illustrated in FIG. 10 may not provide sufficient cooling capacity.

In addition to the cooling system illustrated in FIG. 11, the cooling system 38 illustrated in FIG. 12 furhter comprises a thermal energy storage 20a, fluidly connectable to the second supplementary heat exchanger 39b via a fourth cooling loop comprising the fourth coolant flow lines 19cd and valves V7, V8. The thermal energy storage 29 is further fluidly connectable to the first secondary heat exchanger 39 via a fifth cooling loop comprising the fifth coolant flow lines 19ce and valves v4 and v3. The first, second and third coolant flow lines further comprises valves V1-V6.

FIG. 12 illustrates cooling of hydrogen with a cooling system 38 comprising a thermal energy storage 20a, wherein the thermal energy storage 38 is configured for cooling coolant flowing in a second cooling loop a the second supplementary heat exchanger 39b. The stipulated lines illustrates lines wherein the coolant flow is terminated and/or wherein the cooling loop is inactive.

In a first example, valves V3, V4, V5, V6 are closed, while valves V1, V2 and V7, V8 are open. This enables flow in the fourth cooling loop via the coolant flow lines 19cd from the thermal energy storage 20a to the second supplementary heat exchanger 39b. Furthermore, this also enables flow of coolant in the first cooling loop comprising the coolant flow lines 19ca. Thereby, coolant is circulating to the thermal energy storage where it is cooled and from the thermal energy storage to the second supplementary heat exchanger wherein coolant in the second cooling loop comprising coolant flow lines 19cb is cooled by the coolant cooled in the thermal energy storage 20a. The coolant circulating in the first cooling loop comprising the coolant flow lines 19ca, the first heat exchanger 39a and the heat exchanger 8 is cooled by the first supplementary heat exchanger 39a, and thereby is able to cool hydrogen flowing in the heat exchanger 8 via the hydrogen pipe 4. This use of the thermal energy storage is advantageous in that it increases the cooling capacity of the cooling system 38. Advantageously, the cooling system may be utilized in conditions where the ambient temperature is, e.g., above 40 degrees Celsius. Advantageously, the dry heater may be utilized as described in relation to FIG. 11 for cooling hydrogen during periods of the day (including night, eventing, morning etc.) where the ambient temperature is, e.g., below 40 degrease, such as below 38 degrees Celsius, such as below 35 degrees Celsius, such as below 30 degrees Celsius, whereas the thermal energy storage may be utilized for cooling hydrogen as described in relation to FIG. 12 during periods where the ambient temperature is above 30 degrees Celsius, such as above 35 degrees Celsius, such a sabove 40 degrees Celsius, such as above 45 degrees Celsius. A controller may control the cooling system 38 according to the ambient temperature and thereby decide whether to use the dry cooler and/or the thermal energy storage for cooling. In some situations, both the dry cooler and the thermal energy storage may be utilized for cooling.

The thermal energy storage may be rebuild during low utility periods, e.g., during night time, and/or simply, when the cooling system is not applied to cool hydrogen. E.g., when the cooling system is implemented in a hydrogen refueling station, the thermal energy storage may be reestablished in periods where no vehicle is being refueled with the hydrogen refueling station.

Optionally, in an embodiment of the disclosure the thermal energy storage 20a may be fluidly connected via flow coolant flow loop lines to the first supplementary heat exchanger. In this configuration, the thermal energy storage 20a may not necessarily be connected to the second supplementary heat exchanger 20a. further optionally, the thermal energy storage may be directly connected to the heat exchanger 8, to provide cooling of hydrogen in the hydrogen pipe via the heat exchanger 8.

Optionally, the cooling system may be used in a standalone configuration wherein the cooling system may utilize different types of heat exchangers. Hence the cooling system is not limited to the use of the heat exchangers illustrated in, e.g., FIG. 1b, FIG. 1a, FIG. 5, FIG. 8 and FIG. 9.

FIG. 13 schematically illustrates reestablishment of a thermal energy storage 20a of a cooling system 38. The cooling system is substantially identical to the cooling system illustrated in FIG. 12, and comprises the same components.

In an example wherein the thermal energy storage is reestablished, valves V5, V6 and V3, V4 are opened, while the valves V1, V2, V7, V8 are closed. Thereby coolant is circulating in a fifth cooling loop comprising the coolant flow loop lines 19ce, the thermal energy storage 20a and the first supplementary heat exchanger 39a. Coolant is further circulating in the second cooling loop comprising the second supplementary heat exchanger 39b and the coolant flow lines 19cb and also coolant is circulating in the third cooling loop comprising the dry cooler 40 and the third coolant flow lines 19cc. Thereby, the thermal energy storage 20a is reestablished based on cooling using the second cooling loop and the dry cooler 40. As previously described, this mode of operation of the cooling system may advantageously be performed during low utility periods of the cooling system. Optionally, the cooling system may be used in a standalone configuration wherein the cooling system may utilize different types of heat exchangers. Hence the cooling system is not limited to the use of the heat exchangers illustrated in, e.g., FIG. 1b, FIG. 1a, FIG. 5, FIG. 8 and FIG. 9.

Optionally, the cooling systems illustrated in, e.g., FIG. 11-13 and FIG. 7 may comprise a plurality of thermal energy storages. The energy storages may be serially connected or connected in parallel and/or the thermal energy storages may be used in different stages of multistage cooling systems, including, e.g., the cooling system illustrated in FIG. 7c. Furthermore, the cooling systems illustrated in FIG. 11-13 may be utilized in stages of a multistage cooling system.

The illustrated cooling systems have been illustrated in schematically to provide useful examples of cooling systems within the scope of the disclosure. Nevertheless, it should be understood that these cooling systems may be modified, e.g., by arranging/positioning, e.g., valves and/or pipes/conduits/flow lines etc. differently, e.g., to accommodate various different implementation requirements. As such, the cooling system may be modified and altered in multiple ways within the scope of the disclosure.

It should be understood that the described and/or illustrated cooling systems may be implemented in a hydrogen refueling station, e.g., to cool hydrogen flowing from a hydrogen storage via one or more hydrogen pipes into a tank of a vehicle being refueled using the hydrogen refueling station. As such, the cooling system(s) may be understood as hydrogen refueling station cooling system. Hence the cooling systems illustrated in, e.g., FIG. 11, FIG. 12 and FIG. 13 may be considered hydrogen refueling station cooling systems.

It should be understood that embodiments of the disclosure may be combined in various ways. E.g., different embodiments of a heat exchanger may be combined and different combinations of embodied heat exchangers may be utilized in cooling systems (hydrogen refueling station cooling systems) according to embodiments of the disclosure. Hence, the embodiments may be varied in a multitude of ways within the scope of the disclosure at least as specified by the claims.

The disclosure has been exemplified above with the purpose of illustration rather than limitation with reference to specific examples of methods and robot systems. Details such as a specific method and system structures have been provided in order to understand embodiments of the disclosure. Note that detailed descriptions of well-known systems, devices, circuits, and methods have been omitted so as to not obscure the description of the disclosure with unnecessary details.

1. A hydrogen refueling station comprising:
a hydrogen storage fluidly connected to a hydrogen dispenser via a hydrogen pipe, said hydrogen dispenser is fluidly connectable to a receiving vessel via a nozzle,
wherein at least part of said hydrogen pipe is coiled and extending in a longitudinal direction of an inner compartment of a high-capacity pipe in pipe heat exchanger configured for cooling a pressurized gaseous hydrogen flowing in said hydrogen pipe part,
wherein said heat exchanger comprises an outer pipe having an outer side, a coolant side defining said inner compartment with a first diameter, a top flange, a bottom flange and a center filler,
wherein said hydrogen pipe part is coiled around said center filler, wherein said hydrogen pipe part enters and leaves said inner compartment via said top flange and said bottom flange, wherein said coil is having a second diameter which is less than said first diameter,
wherein said outer pipe comprising a coolant entrance and a coolant exit, wherein said coolant entrance enable a coolant to enter said inner compartment in a direction perpendicular to the longitudinal direction of said outer pipe,
wherein a coolant pump is configured for introducing said coolant into said inner compartment via said coolant entrance thereby establishing a radial swirling coolant flow in said inner compartment around said center filler towards said coolant exit,
wherein said swirling coolant flow is fluidly in contact with said hydrogen pipe part and thereby facilitating exchange of heat between said swirling coolant and said gaseous hydrogen flowing in said hydrogen pipe part.

2. The hydrogen refueling station according to claim 1, wherein said high-capacity pipe in pipe heat exchanger is configured for cooling an average hydrogen flow through of at least 6.5 kg/min.

3.-4. (canceled)

5. The hydrogen refueling station according to claim 1, wherein said inner compartment is separated in two inner sub-compartments, by a compartment separator.

6.-7. (canceled)

8. The hydrogen refueling station according to claim 1, wherein said coolant entrance is displaced from the center of said outer side when seen in a top view.

9.-14. (canceled)

15. The hydrogen refueling station according to claim 1, wherein said center filler is a solid rod or a hollow pipe comprising additional hydrogen pipes.

16.-18. (canceled)

19. The hydrogen refueling station according to claim 1, wherein two or more parts of hydrogen pipe are connected to said hydrogen pipe via a manifold.

20. The hydrogen refueling station according to claim 1, wherein said two or more parts of hydrogen pipe are coiled with different diameters.

21. (canceled)

22. The hydrogen refueling station according to claim 1, wherein the length of each of said at least part of said hydrogen pipe is 1 meter and 20 meter. between 9 meter and 14 meter.

23. (canceled)

24. The hydrogen refueling station according to claim 1, wherein at least 90% of said hydrogen pipe is coiled and located inside said inner compartment.

25. The hydrogen refueling station according to claim 1, wherein a first manifold set separates flow of pressurized gaseous hydrogen from flow in one hydrogen pipe to flow in 2-9 hydrogen pipe parts.

26.-29. (canceled)

30. A hydrogen refueling station cooling system comprising:
at least two cooling stages for cooling a flow of hydrogen in a hydrogen pipe,
wherein said first cooling stage is configured for cooling gaseous hydrogen in a hydrogen pipe guiding a flow of said gaseous hydrogen from a hydrogen storage through a first heat exchanger, wherein said first heat exchanger is fluidly connected to a thermal energy storage of a coolant flow loop, and
wherein said second cooling stage is configured for cooling said flow of gaseous hydrogen from said first heat exchanger by a third heat exchanger, wherein said third heat exchanger is fluidly connected to a chiller of said coolant flow loop,
wherein said chiller is configured for established said thermal energy storage when there is no flow of gaseous hydrogen in said hydrogen pipe,
wherein at least part of said hydrogen pipe is coiled and extending in a longitudinal direction of an inner compartment of at least said first heat exchanger and/or said third heat exchanger,
wherein said heat exchanger comprises an outer pipe having an outer side, a coolant side defining said inner compartment with a first diameter, a top flange, a bottom flange and a center filler,
wherein said hydrogen pipe part is coiled around said center filler, wherein said hydrogen pipe part enters and leaves said inner compartment via said top flange and said bottom flange, wherein said coil is having a second diameter which is less than said first diameter,
wherein said outer pipe comprising a coolant entrance and a coolant exit, wherein said coolant entrance enable a coolant to enter said inner compartment in a direction perpendicular to the longitudinal direction of said outer pipe,
wherein a coolant pump is configured for introducing said coolant into said inner compartment via said coolant entrance thereby establishing a radial swirling coolant flow in said inner compartment around said center filler towards said coolant exit,
wherein said swirling coolant flow is fluidly in contact with said hydrogen pipe part and thereby facilitating exchange of heat between said swirling coolant and said gaseous hydrogen flowing in said hydrogen pipe part.

31. (canceled)

32. The hydrogen refueling station cooling system according to claim 30, wherein said chiller is configured for cooling coolant where at least one of a coolant pump and a chiller pump is configured for establishing a flow of said cooled coolant in a coolant flow loop into said first heat exchanger, said thermal energy storage and said third heat exchanger.

33. The hydrogen refueling station cooling system according to claim 30, wherein said thermal energy storage is configured for cooling coolant conducted through said first heat exchanger during refueling of a receiving vessel.

34. The hydrogen refueling station cooling system according to claim 30, wherein said third heat exchanger is a pipe in pipe heat exchanger.

35. The hydrogen refueling station cooling system according to claim 30, wherein said hydrogen refueling station cooling system comprises a fourth heat exchanger.

36.-37. (canceled)

38. The hydrogen refueling station cooling system according to claim 30, wherein said hydrogen refueling station cooling system comprises a third cooling stage configured for cooling said flow of gaseous hydrogen from said third high-capacity exchanger by a fourth heat exchanger, wherein said fourth heat exchanger is fluidly connected to a low temperature cooling loop, wherein temperature of coolant of said low temperature cooling loop is reduced by heat exchange with coolant of said coolant flow loop.

39-42. (canceled)

43. A method of assembling a high-capacity pipe in a pipe heat exchanger, the method comprises the steps of providing:
an outer pipe having an inner diameter between 90 mm and 300 mm, two coolant entrances, having an inner diameter of maximum 35 mm, and displaced from the center of said outer pipe and two coolant exits,
at least two hydrogen pipe parts having a coiled part and a non-coiled part,
a top flange and a bottom flange each having through holes for allowing ends of said at least two hydrogen pipe parts to extent through said top and bottom flange,
a center filler, and
a compartment separator having a diameter corresponding to said inner diameter, through holes for allowing ends of said at least two hydrogen pipe parts to extent through said compartment separator and a through hole allowing said center filler to extent through said compartment separator,
wherein said method comprises the steps:
mounting said compartment separator inside said outer pipe thereby establishing a first sub-compartment and a second sub-compartment each comprising a set of one coolant entrance and one coolant exit,
mounting and fastening said center filler in the associated through hole of said compartment separator,
mounting a first of said at least two hydrogen pipe parts in the associated through holes of said compartment separator so that the coiled part thereof is comprised by said first sub-compartment and the non-coiled part is at least partly comprised by said second sub-compartment,
mounting a second of said at least two hydrogen pipe parts in the associated through holes of said compartment separator so that the coiled part thereof is comprised by said second sub-compartment and the non-coiled part is at least partly comprised by said first sub-compartment,
mounting said top and bottom flanges to said outer pipe ensuring that ends of said at least two hydrogen pipe parts are extending through said top and bottom flanges,
fluidly connecting said coolant entrance to a first end of a coolant flow loop,
fluidly connecting said coolant exit to said coolant entrance, and
fluidly connecting said coolant exit to a second end of said coolant flow loop.

44. (canceled)

45. The hydrogen refueling station cooling system according to claim 30, wherein said first heat exchanger and/or said third heat exchanger is a high-capacity pipe in pipe heat exchanger configured for cooling a pressurized gaseous hydrogen flowing in said hydrogen pipe part.

46. (canceled)

47. A heat exchanger for cooling hydrogen, wherein said heat exchanger comprises:
at least part of a hydrogen pipe configured for receiving hydrogen; wherein said at least part of a hydrogen pipe is coiled and extending in a longitudinal direction of an inner compartment of said heat exchanger,
an outer pipe having an outer side, a coolant side defining said inner compartment with a first diameter, a top flange, a bottom flange and a center filler,
wherein said at least part of a hydrogen pipe part is coiled around said center filler, wherein said hydrogen pipe part enters and leaves said inner compartment via said top flange and said bottom flange, wherein said coil is having a second diameter which is less than said first diameter,
wherein said outer pipe comprising a coolant entrance and a coolant exit, wherein said coolant entrance enable a coolant to enter said inner compartment in a direction perpendicular to the longitudinal direction of said outer pipe,
wherein a coolant pump is configured for introducing said coolant into said inner compartment via said coolant entrance thereby establishing a radial swirling coolant flow in said inner compartment around said center filler towards said coolant exit,
wherein said swirling coolant flow is fluidly in contact with said at least part of a hydrogen pipe part and thereby facilitating exchange of heat between said swirling coolant and said received hydrogen flowing in said at least part of a hydrogen pipe part.

48-52. (canceled)
